(19) United States
(12) Patent Application Publication
(10) Pub. No.: US 2026/0369760 A1
(43) Pub. Date: Nov. 19, 2026

(54) Secondary Battery

(71) Applicant: LG Energy Solution, Ltd., Seoul (KR)

(72) Inventors: Hyun Hee Lee, Daejeon (KR); Sang Joon Park, Daejeon (KR); Yong Jong Son, Daejeon (KR); Seung Hyun Noh, Daejeon (KR); Hyun Jung Suh, Daejeon (KR)

(73) Assignee: LG Energy Solution, Ltd., Seoul (KR)

(21) Appl. No.: 19/655,404

(22) Filed: Apr. 22, 2026

(30) Foreign Application Priority Data
Apr. 22, 2025 (KR) 10-2025-0052609
Apr. 20, 2026 (KR) 10-2026-0070527

(51) Int. Cl. H01M 50/184; H01M 50/103; H01M 50/15; H01M 50/188; H01M 50/533; H01M 50/557

(52) U.S. Cl. CPC H01M 50/184; H01M 50/103; H01M 50/15; H01M 50/188; H01M 50/533; H01M 50/557

(57) ABSTRACT

A secondary battery capable of preventing relative rotation between components in a cap assembly may include an electrode assembly, a current collector, a battery casing, and a cap assembly. The cap assembly may include a base plate, an upper gasket, and a terminal. The secondary battery can prevent rotation of components while simplifying an assembly process of the cap assembly.

### CROSS-REFERENCE TO RELATED APPLICATION

The present application claims priority to and the benefit of Korean Patent Application No. 10-2025-0052609 filed on Apr. 22, 2025, and No. 10-2026-0070527 filed on Apr. 20, 2026, in the Korean Intellectual Property Office, the entire disclosure of which is incorporated herein by reference.

### BACKGROUND

### Technical Field

The present disclosure relates to a secondary battery, and more particularly, to a secondary battery in which relative rotation between components in a cap assembly can be prevented.

### Related Art

Recently, as demand for portable electronic products has rapidly increased and the development of electric vehicles, energy storage batteries, robots, satellites, and the like has become more active, research has been actively conducted on high-performance secondary batteries capable of repeated charging and discharging.

Secondary batteries may be classified, according to the shape of their battery casing, into a can-type secondary battery (in which an electrode assembly is embedded in a metal can) and a pouch-type secondary battery (in which an electrode assembly is embedded in a pouch formed of an aluminum laminate sheet). Can-type secondary batteries may also be classified into a cylindrical secondary battery and a prismatic secondary battery according to the shape of the metal can.

In a secondary battery, an electrode tab of the electrode assembly is connected to a current collector by welding. In welding the electrode tab to the current collector, the electrode tab is bent in a bending direction to increase a contact area between the electrode tab and the current collector, the current collector is seated on an upper side of the electrode tab, and welding is then performed.

However, such a configuration may cause damage to a separator during the process of welding the current collector and the electrode tab disposed thereunder. In addition, as the capacity of the secondary battery increases, the number of electrode tabs to be welded increases, thereby causing tabs located farther from the current collector to be insufficiently welded.

Accordingly, it would be desirable to develop a secondary battery that can reduce damage to a separator while stably welding a large number of electrode tabs to a current collector. In addition, it would be desirable to develop a secondary battery that can prevent rotation of components while simplifying an assembly process of a cap assembly.

### SUMMARY

An object of at least one, but not necessarily all, of the aspects of the present disclosure is to provide a secondary battery that can prevent an electrode assembly from being affected when welding an electrode tab to a current collector, and a module, a pack, and a transportation means including the same.

Another object of at least one, but not necessarily all, of the aspects of the present disclosure is to provide a secondary battery that can stably weld a large number of electrode tabs to a current collector when welding the electrode tabs to the current collector, and a module and a pack including the same.

A further object of at least one, but not necessarily all, of the aspects of the present disclosure is to provide a secondary battery that can prevent rotation of components while simplifying an assembly process of a cap assembly, and a module and a pack including the same.

A secondary battery according to an aspect of the present disclosure may include an electrode assembly; a battery casing; and a cap assembly. The electrode assembly may include an electrode portion and at least one electrode tab positioned at a first end of the electrode portion. A current collector may be disposed along the first end of the electrode portion and welded to the electrode tab. The battery casing may have an open end and may accommodate the electrode assembly therein such that the open end of the battery casing is proximate the first end of the electrode portion. The cap assembly may be coupled to the open end of the battery casing. The cap assembly herein may include a base plate; a gasket; and a terminal. The base plate may include a seating portion defining a recess into the base plate and may further include an opening through which extends a current collecting protrusion in electrical communication with the electrode tab of the electrode assembly. In an aspect, the base plate may include a plurality of locking portions positioned along the seating portion asymmetrically with respect to a virtual mirror line bisecting the opening of the seating portion. The gasket may be disposed in the seating portion of the base plate. The gasket may include a bottom portion and a plurality of fixing portions disposed along the bottom portion. The plurality of fixing portions may be coupled to the respective plurality of locking portions. The terminal may be disposed on an upper surface of the bottom portion of the gasket. Further, the terminal may have a plurality of grooves positioned along a lower surface thereof and may receive the respective fixing portions of the gasket therein.

According to an aspect, the seating portion may have a quadrilateral shape or a circular shape.

According to an aspect, a depth of the seating portion may be in a range of 30% to 50% of a thickness of the base plate.

According to an aspect, an area of the opening of the base plate may be in a range of 5% to 20% of an area of the seating portion.

According to an aspect, the plurality of locking portions may be positioned rotationally symmetrically with respect to a center of the opening of the seating portion.

According to an aspect, a sum of areas of the plurality of locking portions may be in a range of 8% to 20% of an area of the seating portion.

According to an aspect, the seating portion may have a quadrilateral shape having a long dimension and a short dimension, and the plurality of locking portions may protrude into the seating portion from an outer perimeter thereof.

According to an aspect, a length that each of the plurality of locking portions protrude into the seating portion along the short dimension of the seating portion may be in a range of 10% to 80% of a length of the short dimension of the seating portion.

According to an aspect, a width of each of the plurality of locking portions along the long dimension of the seating portion may be in a range of 3% to 10% of a length of the long dimension of the seating portion.

According to an aspect, the plurality of locking portions may include at least one protrusion extending upwardly from the recess defined by the seating portion, the at least one protrusion being spaced away from a perimeter of the seating portion.

According to an aspect, the fixing portion may have a convex shape disposed on the upper surface of the bottom portion of the gasket and a concave shape disposed on a lower surface of the bottom portion of the gasket.

According to an aspect, the gasket may include a rib positioned along a peripheral edge of the upper surface of the bottom portion.

According to an aspect, a height of the rib above the upper surface of the bottom portion of the gasket may be in a range 30% to 80% of a height of the terminal.

According to an aspect, the rib may have a longitudinal dimension extending along the perimeter edge of the bottom portion of the gasket, the rib may project away from the upper surface of the bottom portion in a height dimension. The rib may have a thickness dimension orthogonal to the height dimension and the thickness dimension. Further, a thickness of the rib in the thickness dimension may be in a range of 0.5 mm to 1.2 mm.

According to an aspect, a sum of an area(S) of the plurality of locking portions is determined by the following: (Equation 1) S=½×AB/C×N², where A is a length of the base plate (mm), B is an area of the opening relative to the area of the seating portion, C is a thickness of the bas e plate (mm), and N is a quantity of the plurality of locking portions.

According to an aspect, a sum of an area(S) of the plurality of locking portions is determined by the following: (Equation 2) S=⅛×AB/C×N², where A is a length of the base plate (mm), B is an area of the opening relative to an area of the seating portion, C is a thickness of the base plate (mm), N is a quantity of the plurality of locking portions.

A second battery according to another aspect of the present disclosure may include an electrode assembly; a battery casing; and a cap assembly. The electrode assembly may include an electrode portion and at least one electrode tab positioned at a first end of the electrode portion. A current collector may be disposed along the first end of the electrode portion and may be welded to the electrode tab. The battery casing may have an open end and may accommodate the electrode assembly therein such that the open end of the battery casing is proximate the first end of the electrode portion. The cap assembly may be coupled to the open end of the battery casing. In an aspect, the cap assembly may include a base plate; a gasket; and a terminal. The base plate may include a seating portion defining a recess into the base plate. The gasket may be disposed in the seating portion of the base plate. The gasket may include an upwardly-facing surface facing away from the base plate. The upwardly-facing surface may include a lower surface portion, an upper surface portion, and a rib. The upper surface portion may project upwardly from the lower surface portion along an outer peripheral region of the lower surface portion, thereby defining a step between the lower surface portion and the upper surface portion. The rib may extend along a peripheral edge of the upper surface portion. The terminal may be disposed on the upwardly-facing surface of the gasket and may have a groove extending along a peripheral portion of a lower surface thereof. The groove may receive the step defined by the upper surface portion of the gasket.

According to an aspect, a depth of the seating portion may be in a range of 30% to 50% of a thickness of the base plate.

According to an aspect, an area of the upper surface portion may be in a range of 50% to 80% of an area of the lower surface portion.

According to an aspect, a width of the upper surface portion may be in a range of 2 mm to 4 mm.

According to an aspect, the lower surface portion may have a shape being the same as a shape of the seating portion.

A second battery according to another aspect of the present disclosure may include an electrode assembly; a battery casing; and a cap assembly. The electrode assembly may include an electrode portion and at least one electrode tab positioned at a first end of the electrode portion. A current collector may be disposed along the first end of the electrode portion and may be welded to the electrode tab. The battery casing may have an open end and may accommodate the electrode assembly therein such that the open end of the battery casing is proximate the first end of the electrode portion. The cap assembly may be coupled to the open end of the battery casing. The cap assembly may include a base plate; a gasket; and a terminal. The base plate may include a seating portion defining a recess into the base plate. The gasket may be disposed in the seating portion of the base plate. The gasket may include a bottom portion and a rib positioned along a peripheral edge of an upper surface of the bottom portion. The terminal may be disposed on the upper surface of the gasket, such that a lower surface of the terminal is below an upper surface of the base plate.

Two protrusions may be provided and be respectively disposed on one diagonal line of the seating portion.

Four protrusions may be provided and be respectively disposed at corners of the seating portion.

A sum of areas of the plurality of protrusions may be 5 to 10% of an area of the seating portion.

Each of the protrusions may have a shape selected from a group consisting of a cylindrical shape, and a quadrangular prismatic shape.

The fixing portion may have a convex shape toward an upper surface side of the upper gasket and a concave shape on an inner side thereof.

The protrusions, the fixing portions, and the grooves are provided in the same number.

A battery module according to an aspect of the present disclosure may include the secondary battery.

A battery pack according to an aspect of the present disclosure may include the battery module.

A transportation means according to an aspect of the present disclosure may include the battery pack.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view illustrating a secondary battery according to one aspect of the present disclosure;

FIG. 2 is a partially exploded perspective view illustrating the secondary battery according to one aspect of the present disclosure;

FIG. 3 is a perspective view illustrating an electrode assembly in which a plurality of first and second electrode tabs are formed on an electrode portion in the secondary battery according to one aspect of the present disclosure;

FIGS. 4A and 4B are plan views illustrating a first electrode member and a second electrode member, respectively, in the secondary battery according to one aspect of the present disclosure;

FIGS. 5A and 5B are plan views illustrating a third electrode member and a fourth electrode member, respectively, in the secondary battery according to one aspect of the present disclosure;

FIG. 6 is a perspective view illustrating a secondary battery according to one aspect of the present disclosure.

FIG. 7 is a perspective view illustrating an electrode assembly having a plurality of first through fourth electrode tabs at one end in the secondary battery according to an aspect of the present disclosure.

FIG. 8 is a perspective view illustrating a current collector in the secondary battery according to one aspect of the present disclosure;

FIG. 9 is a side view illustrating a current collector in the secondary battery according to one aspect of the present disclosure;

FIGS. 10A and 10B are cross-sectional views illustrating a cap assembly in the secondary battery according to aspects of the present disclosure;

FIG. 11 includes an exploded perspective view and a cross-sectional view along section A-A′, illustrating the cap assembly according to one aspect of the present disclosure;

FIG. 12 is a top plan view illustrating a base plate according to one aspect of the present disclosure;

FIG. 13 is a top plan view illustrating a base plate according to another aspect of the present disclosure;

FIG. 14 is a top plan view illustrating an upper gasket according to one aspect of the present disclosure;

FIG. 15 is an exploded perspective view illustrating a cap assembly according to another aspect of the present disclosure;

FIGS. 16A and 16B are exploded perspective views illustrating cap assemblies according to additional aspects of the present disclosure;

FIG. 17 is an exploded view illustrating a base plate and a gasket in a cap assembly according to another aspect of the present disclosure.

FIGS. 18A and 18B are cross-sectional views illustrating a state in which a cap assembly and a current collector tab are coupled according to an aspect of the present invention.

FIG. 19 is a top plan view illustrating a cap assembly according to another aspect of the present disclosure;

FIG. 20 includes an exploded perspective view and a cross-sectional view along section B-B′, illustrating a cap assembly according to another aspect of the present disclosure;

FIGS. 21A and 21B are cross-sectional views illustrating a state in which a cap assembly and a current-collecting protrusion are coupled according to another aspect of the present disclosure.

FIG. 22 includes an exploded perspective view and a cross-sectional view along section C-C′, illustrating a cap assembly according to another aspect of the present disclosure;

FIG. 23 is an exploded perspective view illustrating a cap assembly according to another aspect of the present disclosure;

FIG. 24 is an exploded perspective view illustrating a cap assembly according to another aspect of the present disclosure;

FIG. 25 is an exploded perspective view illustrating a cap assembly according to another aspect of the present disclosure;

FIGS. 26A and 26B are cross-sectional views illustrating states in which a cap assembly and a current-collecting protrusion are coupled according to additional aspects of the present disclosure.

FIG. 27 is an exploded perspective view illustrating a secondary battery according to an aspect of the present disclosure.

FIG. 28 is an exploded perspective view illustrating a cap assembly of a secondary battery according to an aspect of the present invention.

FIGS. 29A and 29B are cross-sectional views illustrating the state in which a cap assembly and a current collector are coupled in a secondary battery according to additional aspects of the present disclosure.

FIG. 30 is a flowchart illustrating a method of manufacturing a secondary battery according to one aspect of the present disclosure;

FIG. 31 is a top plan view illustrating a state in which a plurality of first electrode tabs and a plurality of second electrode tabs are respectively grouped in a secondary battery according to one aspect of the present disclosure;

FIG. 32 is a top plan view illustrating a state in which a current collector is disposed between a plurality of first electrode tabs and a plurality of second electrode tabs in a secondary battery according to one aspect of the present disclosure;

FIG. 33 is a perspective view illustrating a state in which a current collector and first and second electrode tabs are welded in a secondary battery according to one aspect of the present disclosure; and

FIG. 34 is a perspective view illustrating a state in which a cap assembly is coupled to an electrode assembly in a secondary battery according to one aspect of the present disclosure.

### DETAILED DESCRIPTION

Since the present disclosure may be modified in various forms and may have various aspects, particular aspects will be illustrated in the accompanying drawings and described in detail with reference to the drawings. However, this is not intended to limit the present disclosure to particular modes of practice, and it is to be appreciated that all changes, equivalents, and substitutes that do not depart from the spirit and technical scope of the present disclosure are encompassed in the present disclosure.

The terminology used herein is for the purpose of describing particular aspects only and is not intended to be limiting the present disclosure. In the present disclosure, the singular forms are intended to include the plural forms as well, unless the context clearly indicates otherwise. It will be further understood that the terms “comprise”, “include”, “have”, etc. when used in this specification, are intended to specify the presence of stated features, integers, steps, operations, elements, components, and/or combinations of them, but do not preclude the presence or addition of one or more other features, integers, steps, operations, elements, components, and/or combinations thereof.

Hereinafter, preferred aspects of the present disclosure will be described in detail with reference to the accompanying drawings. It should be noted that like reference numerals refer to like elements throughout the attached drawings. Details of well-known configurations and functions may be omitted to avoid unnecessarily obscuring the gist of the present disclosure. For the same reason, in the accompanying drawings, some elements are enlarged, omitted, or depicted schematically.

Hereinafter, a secondary battery according to an aspect of the present disclosure will be described.

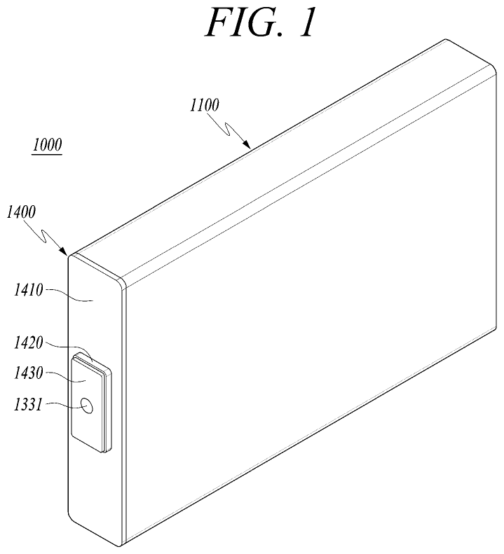

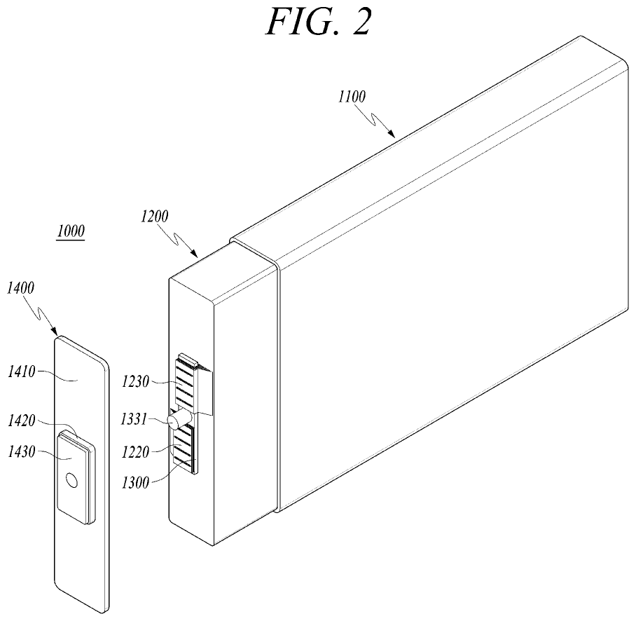

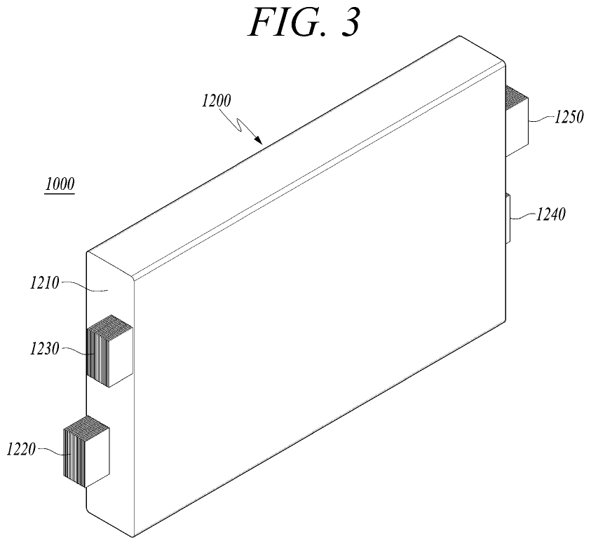

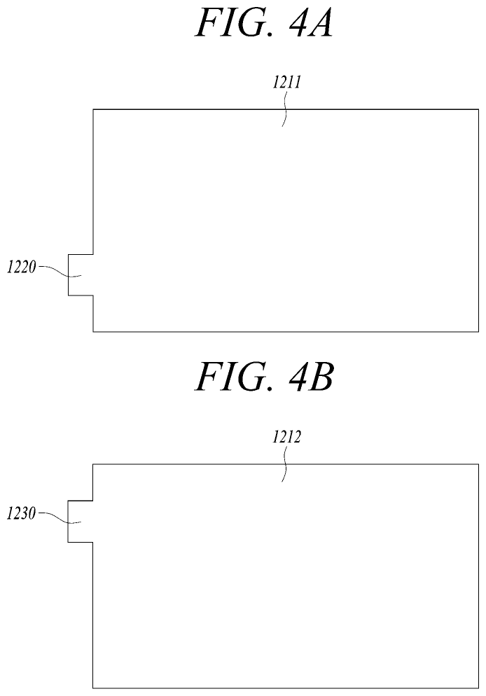

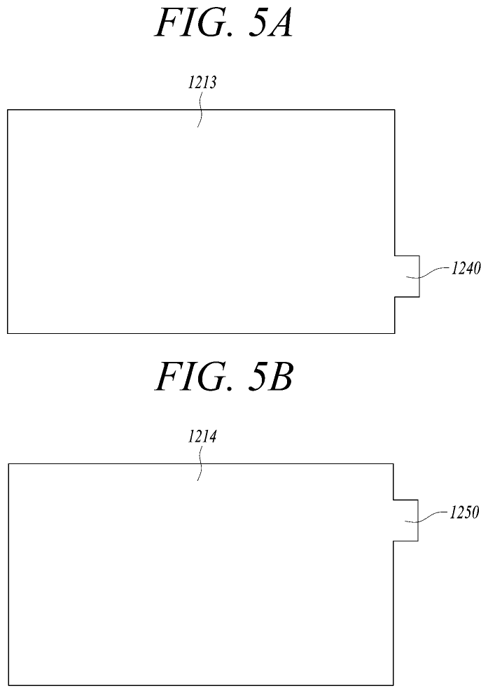

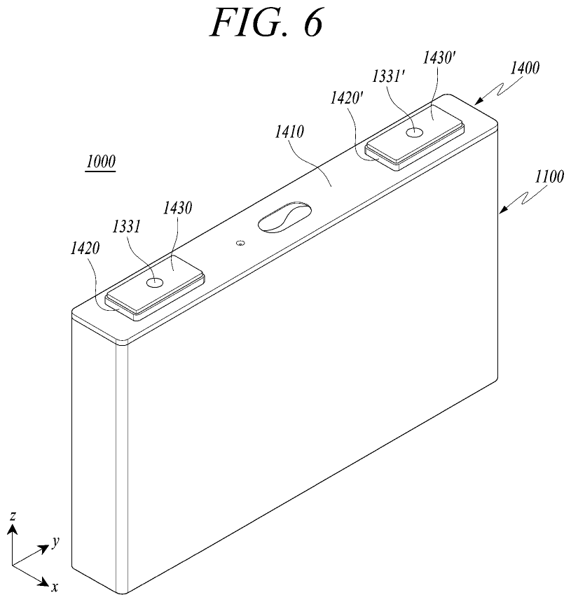

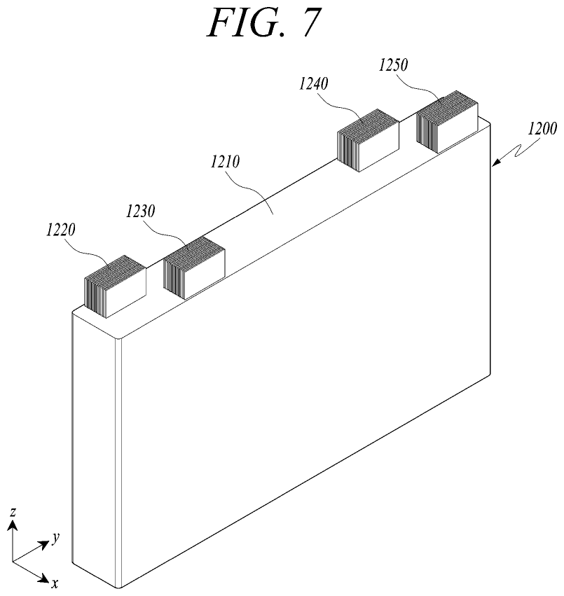

FIG. 1 is a view illustrating a secondary battery according to one aspect of the present disclosure, and FIG. 2 is a partially exploded view illustrating the secondary battery. FIG. 3 is a view illustrating an electrode assembly in which a plurality of first and second electrode tabs are formed on an electrode portion in the secondary battery according to one aspect of the present disclosure, where FIGS. 4A and 4B are views illustrating a first electrode member and a second electrode member, respectively, and FIGS. 5A and 5B are views illustrating a third electrode member and a fourth electrode member, respectively, in such electrode assembly. FIGS. 6 and 7 are views illustrating a current collector in the secondary battery according to one aspect of the present disclosure.

As shown in FIGS. 1 and 2, a secondary battery 1000 according to one aspect of the present disclosure includes a casing 1100, an electrode assembly 1200, a current collector 1300, and a cap assembly 1400.

The casing 1100 forms an exterior of the secondary battery 1000. The casing 1100 has an internal space configured to accommodate the electrode assembly 1200, with an opening defined on one surface thereof. In this aspect, the casing 1100 has a rectangular parallelepiped shape, but the shape of the casing 1100 may be variously changed without being limited thereto. The casing 1100 may be made of a rigid material that may protect the electrode assembly 1200 accommodated therein. For example, the casing 1100 may be made of a metal such as aluminum or stainless steel.

An electrolyte may be accommodated in the casing 1100 together with the electrode assembly 1200. The electrolyte may be composed of a lithium salt such as LiPF₆ or LiBF₄ in an organic solvent such as EC, PC, DEC, EMC, or DMC. The electrolyte may be in a liquid, solid, or gel state.

The electrode assembly 1200 is accommodated in the casing 1100. As illustrated in FIG. 3, the electrode assembly 1200 includes an electrode portion 1210, a plurality of first electrode tabs 1220, and a plurality of second electrode tabs 1230. The plurality of first electrode tabs 1220 and the plurality of second electrode tabs 1230 are disposed on one end of the electrode portion 1210. The plurality of first electrode tabs 1220 are aligned with each other, and the plurality of second electrode tabs 1230 are aligned with each other. The aligned plurality of first electrode tabs 1220 and the aligned plurality of second electrode tabs 1230 are offset from one another so as not to overlap each other in a width direction and a length direction of the electrode assembly 1200.

Specifically, the electrode portion 1210 includes a plurality of first electrode members 1211, a plurality of second electrode members 1212, a plurality of third electrode members 1213, a plurality of fourth electrode members 1214, and at least one separator.

An active material may be applied to the plurality of first electrode members 1211, the plurality of second electrode members 1212, the plurality of third electrode members 1213, and the plurality of fourth electrode members 1214. In the plurality of first electrode members 1211 and the plurality of second electrode members 1212, an active material such as a transition metal oxide may be applied to a metal plate such as aluminum. The plurality of first electrode members 1211 and the plurality of second electrode members 1212 may have the same polarity and may be positive electrode plates. In the plurality of third electrode members 1213 and the plurality of fourth electrode members 1214, an active material such as graphite or carbon may be applied to a metal plate such as copper or nickel. The plurality of third electrode members 1213 and the plurality of fourth electrode members 1214 may have the same polarity and may be negative electrode plates.

The separator is positioned between each of the plurality of first to fourth electrode members 1211, 1212, 1213, and 1214 to prevent a short circuit between the plurality of first to fourth electrode members 1211, 1212, 1213, and 1214. The separator may be made of polyethylene, polypropylene, or a composite thereof.

The electrode portion 1210 may be formed by disposing the separator between the first electrode member 1211 and the third electrode member 1213 that are sequentially arranged, and between the second electrode member 1212 and the fourth electrode member 1214 that are sequentially arranged. That is, in one aspect, the electrode portion 1210 is formed such that one side of the electrode portion 1210 is formed by stacking (e.g., tens to hundreds of times) the first electrode member 1211, the separator, the third electrode member 1213, and the separator in this order, and the other side of the electrode portion 1210 is formed by stacking (e.g., tens to hundreds of times) the second electrode member 1212, the separator, the fourth electrode member 1214, and the separator in this order. In another aspect, the electrode portion 1210 may be formed by stacking, in this order, the first electrode member 1211, the separator, the third electrode member 1213, the separator, the second electrode member 1212, the separator, the fourth electrode member 1214, and the separator, and then winding the stacked structure.

In this aspect, the electrode assembly 1200 includes one electrode portion 1210, but in another aspect, the electrode assembly 1200 may include a plurality of electrode portions 1210. The plurality of electrode portions 1210 may be electrically connected to each other.

Electrode tabs 1220, 1230, 1240, and 1250 to which no active material is applied are formed on a respective end of each of the plurality of first to fourth electrode members 1211, 1212, 1213, and 1214. In one aspect, the electrode members 1211, 1212, 1213, and 1214 and the electrode tabs 1220, 1230, 1240, and 1250 may be integrally formed by cutting a predetermined portion from a single metal plate using a laser or the like so as to create the electrode members 1211, 1212, 1213, and 1214 having the respective electrode tabs 1220, 1230, 1240, and 1250 integrally connected thereto. The plurality of electrode tabs 1220, 1230, 1240, and 1250 may be formed in a direction toward the cap assembly 1400.

The first electrode tab 1220 is formed at a first position of the first electrode member 1211. The second electrode tab 1230 is formed at a second position of the second electrode member 1212 (FIGS. 4A and 4B). Similarly, the third electrode tab 1240 may be formed at a third position of the third electrode member 1213, and the fourth electrode tab 1250 may be formed at a fourth position of the fourth electrode member 1214 (FIGS. 5A and 5B).

The plurality of first electrode members 1211 and the plurality of third electrode members 1213 may be alternately stacked with the separator interposed therebetween. A stack of the plurality of first electrode members 1211 and the plurality of third electrode members 1213 forms one half of the electrode portion 1210.

The plurality of second electrode members 1212 and the plurality of fourth electrode members 1214 may be alternately stacked with the separator interposed therebetween. A stack of the plurality of second electrode members 1212 and the plurality of fourth electrode members 1214 forms the remaining half of the electrode portion 1210.

The stack of the plurality of first electrode members 1211 and the plurality of third electrode members 1213 and the stack of the plurality of second electrode members 1212 and the plurality of fourth electrode members 1214 are connected in a width direction of the electrode portion 1210. In forming the electrode assembly 1200, the plurality of first electrode members 1211 and the plurality of third electrode members 1213 may be stacked, and then the plurality of second electrode members 1212 and the plurality of fourth electrode members 1214 may be stacked.

When the plurality of first to fourth electrode members 1211, 1212, 1213, and 1214 are stacked, the plurality of first electrode tabs 1220 overlap each other at the first position, and the plurality of second electrode tabs 1230 overlap each other at the second position. That is, the plurality of first electrode tabs 1220 are grouped at the first position, and the plurality of second electrode tabs 1230 are grouped at the second position. The first position and the second position may be spaced apart from each other on the electrode members, and the grouped plurality of first electrode tabs 1220 and the grouped plurality of second electrode tabs 1230 may be spaced apart from each other in the width direction and the length direction of the electrode assembly 1200.

The grouped plurality of first electrode tabs 1220 are primarily welded to each other, and the grouped plurality of second electrode tabs 1230 are primarily welded to each other.

The plurality of first electrode tabs 1220 and the plurality of second electrode tabs 1230 are electrode tabs having the same polarity. In order to stably weld a large number of electrode tabs, the electrode tabs are spaced apart from each other in the width direction and the length direction of the electrode assembly 1200 and primarily welded, and then are secondarily welded onto the current collector. That is, one electrode tab is formed on one electrode member. However, by forming the electrode tabs at different positions on the respective electrode members, two electrode tab groups having different positions of the same polarity are formed after stacking of the electrode members. In another aspect, two or more electrode tabs having different positions of the same polarity may be formed.

When the plurality of first to fourth electrode members 1211, 1212, 1213, and 1214 are stacked, the plurality of third electrode tabs 1240 overlap each other at the third position, and the plurality of fourth electrode tabs 1250 overlap each other at the fourth position. That is, the plurality of third electrode tabs 1240 are grouped at the third position, and the plurality of fourth electrode tabs 1250 are grouped at the fourth position. The third position and the fourth position are spaced apart from each other on the electrode members, and the grouped plurality of third electrode tabs 1240 and the grouped plurality of fourth electrode tabs 1250 may be spaced apart from each other in the width direction and the length direction of the electrode assembly 1200.

The plurality of third electrode tabs 1240 and the plurality of fourth electrode tabs 1250 are electrode tabs having the same polarity.

The plurality of electrode tabs 1220, 1230, 1240, and 1250 overlapped at respective positions may be connected to each other by ultrasonic welding, laser welding, or the like so as to facilitate current flow. A plurality of electrode tabs having the same polarity may be formed at respective ends of the electrode assembly; however, the present disclosure is not limited thereto. In a modified aspect, a plurality of electrode tabs having different polarities may be formed at one end of the electrode assembly, spaced apart from one another.

As shown in FIG. 6, in a secondary battery 1000 according to an aspect of the present disclosure, two terminals may be disposed at one end. In this instance, the case 1100 may be formed with an internal space capable of accommodating an electrode assembly 1200, and an opening may be formed at one end.

The electrode assembly 1200 may be accommodated within the interior of the case 1100. As shown in FIG. 7, the electrode assembly 1200 may comprise an electrode portion 1210, a plurality of first electrode tabs 1220, a plurality of second electrode tabs 1230, a plurality of third electrode tabs 1240, and a plurality of fourth electrode tabs 1250. The plurality of first electrode tabs 1220, the plurality of second electrode tabs 1230, the plurality of third electrode tabs 1240, and the plurality of fourth electrode tabs 1250 may be disposed at one end of the electrode portion 1210.

At one side of one end of the electrode assembly 1200, a plurality of first electrode tabs 1220 may be aligned with one another, and a plurality of second electrode tabs 1230 may be aligned with one another. At the other side of said one end of the electrode assembly 1200, a plurality of third electrode tabs 1240 may be aligned with one another, and a plurality of fourth electrode tabs 1250 may be aligned with one another. The respectively aligned pluralities of first electrode tabs 1220, second electrode tabs 1230, third electrode tabs 1240, and fourth electrode tabs 1250 may be arranged such that they do not overlap with one another in the width direction (x-direction) and the length direction (y-direction) of the electrode assembly 1200.

The grouped multiple first electrode tabs 1220 may be primarily welded to one another; the multiple second electrode tabs 1230 to one another; the multiple third electrode tabs 1240 to one another; and the multiple fourth electrode tabs 1250 to one another, respectively.

The plurality of first electrode tabs 1220 and the plurality of second electrode tabs 1230 may be electrode tabs of the same polarity. To stably weld a large number of electrode tabs, the tabs may be spaced apart in the width and length directions of the electrode assembly 1200, respectively, for a primary weld and subsequently subjected to a secondary weld on a first current collector. Similarly, the plurality of third electrode tabs 1240 and the plurality of fourth electrode tabs 1250 may be electrode tabs of the same polarity. The tabs may be spaced apart in the width and length directions of the electrode assembly 1200, respectively, for a primary weld and subsequently subjected to a secondary weld on a second current collector. In other words, while a single electrode tab may be formed on each individual electrode member, by varying the position at which the electrode tab is formed on each respective electrode member, two groups of electrode tabs sharing the same polarity can be positioned at distinct locations following the stacking of the electrode members. The plurality of first and second electrode tabs 1220, 1230 and the plurality of third and fourth electrode tabs 1240, 1250 may have different polarities from each other.

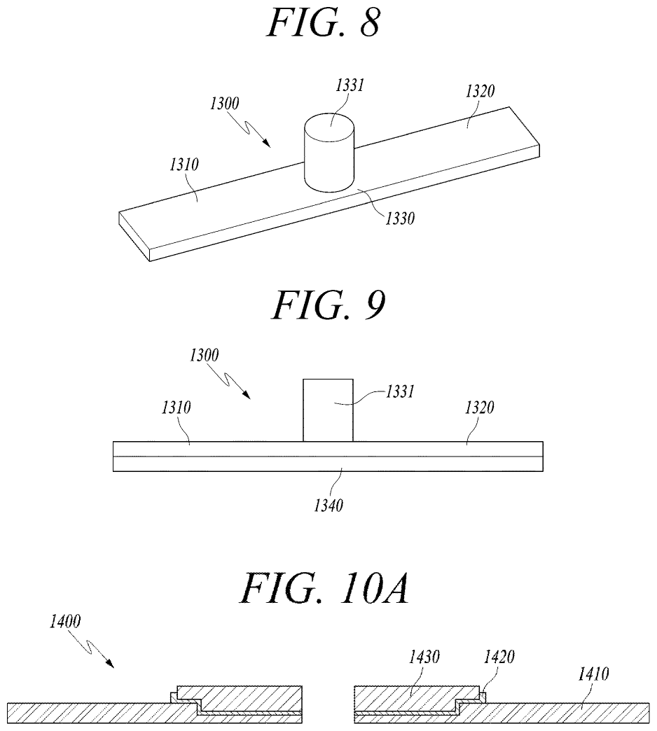

As illustrated in FIG. 8, the current collector 1300 includes a first current collecting portion 1310, a second current collecting portion 1320, and a connecting portion 1330.

The current collector 1300 may have a rectangular shape extending in the length direction of the electrode assembly 1200. The current collector 1300 may have the first current collecting portion 1310, the connecting portion 1330, and the second current collecting portion 1320 sequentially arranged along the length direction of the rectangular shape.

The first current collecting portion 1310 is welded to the plurality of first electrode tabs 1220. The plurality of first electrode tabs 1220 may be bent onto the first current collecting portion 1310 and welded thereto. The second current collecting portion 1320 is welded to the plurality of second electrode tabs 1230. The plurality of second electrode tabs 1230 may be bent onto the second current collecting portion 1320 and welded thereto.

The connecting portion 1330 is disposed between the first current collecting portion 1310 and the second current collecting portion 1320. The first current collecting portion 1310 and the second current collecting portion 1320 are respectively connected to opposite sides of the connecting portion 1330. Since the first current collecting portion 1310 and the second current collecting portion 1320 are spaced apart from each other by the connecting portion 1330, the plurality of first electrode tabs 1220 and the plurality of second electrode tabs 1230 do not interfere with each other when being welded to the first current collecting portion 1310 and the second current collecting portion 1320, respectively.

Two current collectors 1300 may be provided, and materials of the current collectors 1300 may be the same as those of the first and second electrode tabs 1220 and 1230 or the third and fourth electrode tabs 1240 and 1250. That is, the current collector 1300 may be formed of aluminum, or may be formed of copper or nickel.

A current collecting protrusion 1331 is provided on the connecting portion 1330. The current collecting protrusion 1331 is electrically connected to an electrode terminal. A material of the current collecting protrusion 1331 may be the same as or different from a material of the connecting portion 1330. For example, both the connecting portion 1330 and the current collecting protrusion 1331 may be formed of aluminum. Alternatively, the connecting portion 1330 may be formed of copper, and the current collecting protrusion 1331 may be formed of aluminum. When the material of the current collecting protrusion 1331 is the same as the material of the connecting portion 1330, the connecting portion 1330 and the current collecting protrusion 1331 may be integrally formed.

The current collector 1300 may have a thickness of 0.5 to 3.0 mm. In the present disclosure, the current collector 1300 is positioned on the electrode portion 1210, and the electrode tabs 1220 and 1230 are positioned on the current collector 1300 and welded from upper sides thereof, thereby securing the thickness of the current collector 1300. Thus, durability of the secondary battery may also be improved.

A width of the current collector 1300 may be 0.5 to 0.8 times a width of the electrode assembly 1200. As used herein, the “width” or “width direction” of the electrode assembly (or the current collector) refers to the direction along which the electrode members are stacked to define the electrode portion, whereas the “length” or “length direction” of the electrode assembly (or the current collector) refers to a direction orthogonal to the “width direction.” As noted above, the first current collecting portion 1310 of the current collector 1300 may be spaced apart from the second current collecting portion 1320 along the length direction.

According to the present disclosure, since the electrode tabs are positioned on the current collector 1300 and welding is performed from the upper sides of the electrode tabs, there is little to no risk of damaging the separator provided in the electrode portion.

In the related art, welding is typically performed after disposing the current collector on the upper sides of the electrode tabs, and thus a high laser output is required to deliver heat to the electrode tabs located under the current collector. However, according to the present disclosure, since the electrode tabs are disposed on the upper side of the current collector, welding may be performed with a lower output. Further, since it is not necessary to melt a lower portion of the current collector, a thickness of the current collector may be increased to protect the separator, and thereby, durability of the secondary battery may also be improved.

As illustrated in FIG. 9, an insulator 1340 may be disposed under the current collector 1300. The insulator 1340 may be an insulating plate or an insulating film. The electrode tabs 1220 and 1230 and the electrode portion 1210 may be further protected by the insulator 1340.

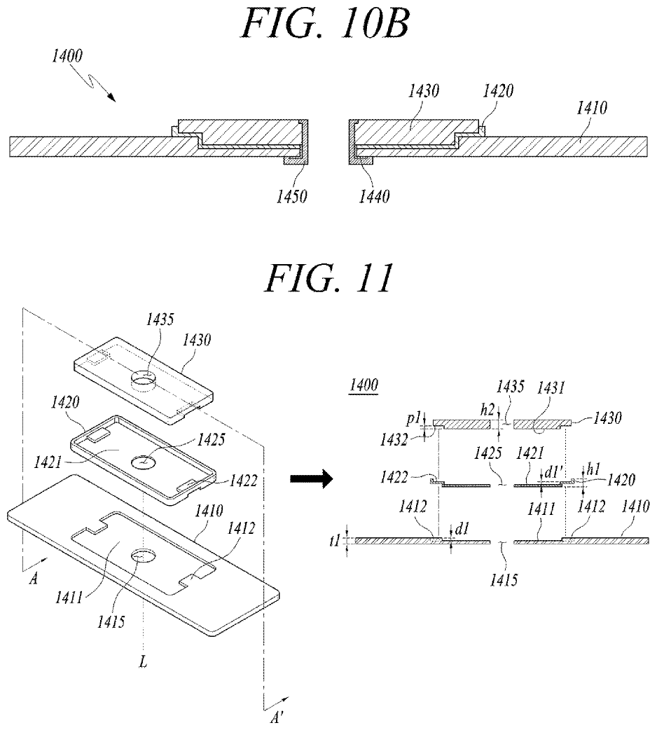

The cap assembly 1400 seals an opening of the casing 1100 in which the electrode assembly 1200 is accommodated. The cap assembly 1400 includes a base plate 1410, an upper gasket 1420, and a terminal 1430. It may be provided with an annular gasket 1440 and rivets 1450 (FIG. 10B). An insulating member (not shown) may be coupled to the bottom of the cap assembly.

Hereinafter, a secondary battery including a cap assembly according to a first aspect of the present disclosure will be described.

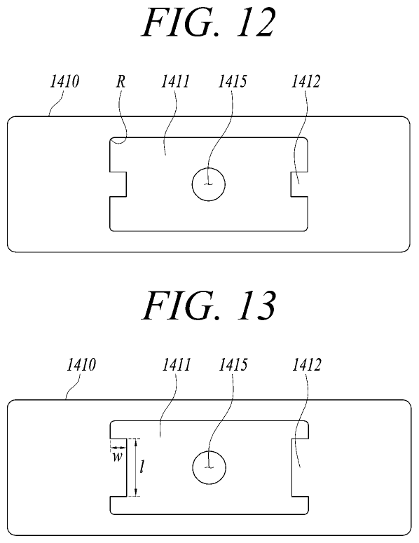

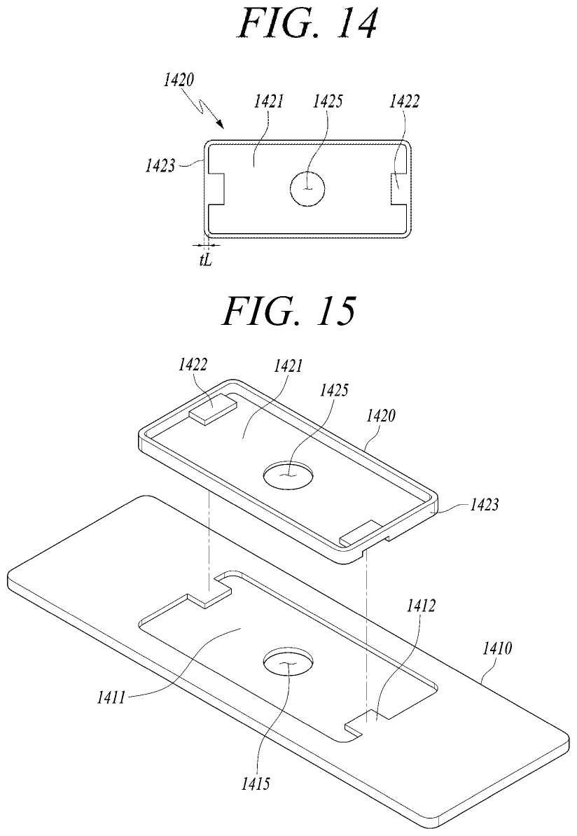

FIGS. 10A and 10B are cross-sectional views illustrating a cap assembly in the secondary battery according to one aspect of the present disclosure, and FIG. 11 includes exploded views illustrating the cap assembly according to one aspect of the present disclosure. FIG. 12 is a view illustrating a base plate according to one aspect of the present disclosure, FIG. 13 is a view illustrating a base plate according to another aspect of the present disclosure, and FIG. 14 is a view illustrating an upper gasket according to one aspect of the present disclosure.

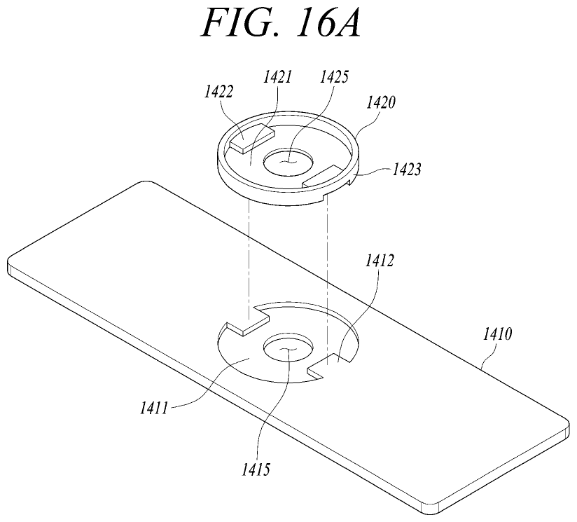

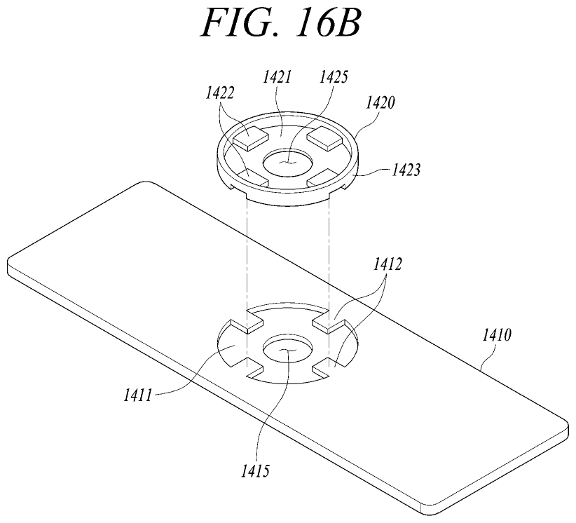

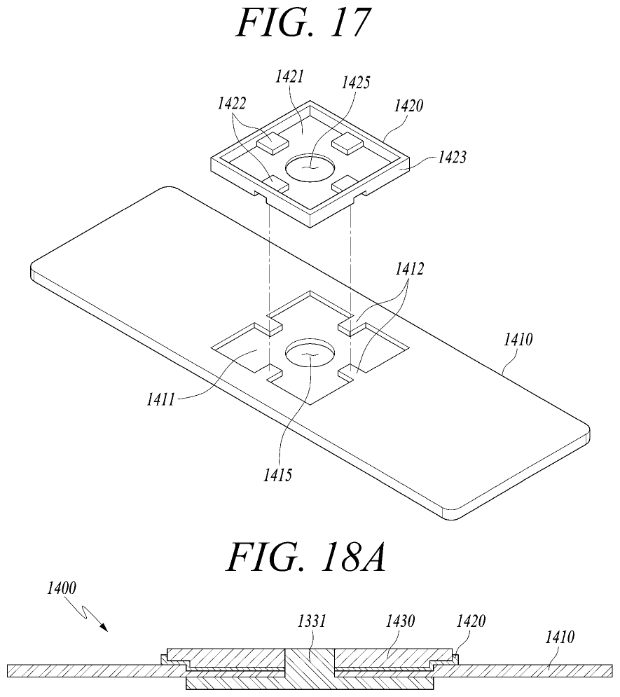

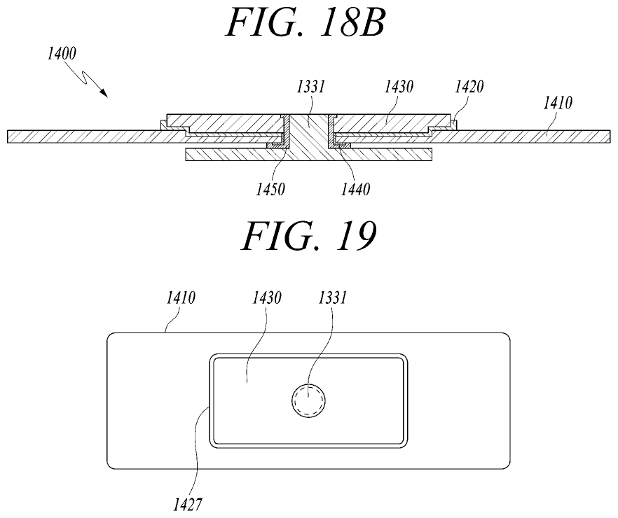

FIG. 15 is a view illustrating a cap assembly according to another aspect of the present disclosure, FIGS. 16A and 16B are views illustrating a cap assembly according to additional aspects of the present disclosure, FIG. 17 is an exploded view illustrating a base plate and a gasket in a cap assembly according to another aspect of the present disclosure, FIGS. 18A and 18B are cross-sectional views illustrating a state in which a cap assembly and a current collector tab are coupled according to an aspect of the present invention, and FIG. 19 is a view illustrating a cap assembly according to another aspect of the present disclosure.

As illustrated in FIGS. 10A, 10B and 11, the cap assembly 1400 includes a base plate 1410, an upper gasket 1420, and a terminal 1430.

The base plate 1410 may have a plate shape that covers an opening of the casing 1100. The base plate 1410 may have a shape corresponding to a shape of the opening of the casing 1100. The base plate 1410 may be formed of the same material as the casing 1100 and may be fixed on the opening of the casing 1100 by a method such as laser welding. The radius of curvature of the corners of the base plate 1410 may be 1 to 4 mm, for example 1.6 to 1.8 mm.

The base plate 1410 may include a seating portion 1411 and a locking portion 1412. The seating portion 1411 forms a flat surface recessed downward from an upper surface of the base plate 1410. The seating portion 1411 may have a quadrilateral shape or a circular shape. A lower surface of the seating portion 1411 is in contact with a lower surface of the upper gasket 1420. Referring to FIG. 12, a depth d1 of the seating portion 1411 may be 30 to 50% of a thickness t1 of the base plate 1410. When the depth d1 of the seating portion 1411 is greater than 50% of the thickness t1 of the base plate 1410, strength of the base plate 1410 may be weakened. If the depth (d1) of the seating portion 1411 is less than 30% of the thickness (t1) of the base plate 1410, the engagement strength with the gasket 1420 may be weakened.

If the seating portion 1411 is rectangular, the radius of curvature of the corners of the seating portion 1411 may be 2 to 3 mm, preferably 2.5 mm. To increase the coefficient of friction of the surface of the seating portion 1411, a material such as silicone may be applied to the surface of the seating portion 1411, or the surface roughness may be increased through surface treatment.

Meanwhile, the area of one seating portion 1411 relative to the base plate 1410 may be 8 to 20%, preferably 11 to 14%. In this aspect, a single seating portion 1411 is formed on the base plate 1410. However, in cases where two seating portions are formed on the base plate 1410, the sum of the surface areas of the two seating portions may be 8% to 20%, and preferably 11% to 14%, relative to the base plate 1410.

An opening 1415 is formed at a center of the seating portion 1411. During assembly of the cap assembly 1400, the current collecting protrusion 1331 of the current collector 1300 is introduced through the opening 1415. An area of the opening 1415 may be 5 to 20%, preferably 14% of an area of the seating portion 1411. By providing a current collecting protrusion 1331 having a sufficient diameter, internal resistance may be reduced when electricity generated in the secondary battery is output, and thereby, heat generation may be reduced.

The locking portion 1412 may be disposed on one side or the other side, or on both sides, of the seating portion 1411. The locking portion 1412 is formed by extending an upper surface of the base plate 1410 toward a central region of the seating portion 1411 such that the locking portion 1412 protrudes into the seating portion from an outer perimeter thereof. The locking portion 1412 may have a quadrilateral shape or a semicircular shape. The locking portion 1412 forms a step with respect to the lower surface of the seating portion 1411.

The engagement between either or both of the seating portion 1411 and the locking portions 1412 with the upper gasket 1420 may help to prevent rotation between the upper gasket 1420 and the base plate 1410. Thus, the shape of the seating portion 1411 and the shape and the number of the locking portions 1412 may be selected as needed or as appropriate. For example, as illustrated in FIG. 13, the seating portion 1411 may have a rectangular shape. The locking portion 1412 may have, for example, a quadrilateral shape, and two locking portions 1412 may be disposed respectively on short sides of the seating portion 1411.

As illustrated in FIG. 12, a sum of areas (B) of two locking portions 1412 may be 1 to 10%, preferably 2%, of an area (A) of the seating portion 1411. The upper gasket 1420 and the terminal 1430 are sequentially stacked on the seating portion 1411 of the base plate 1410. When a total area of the locking portions 1412 exceeds 10%, an area of a lower surface of the terminal 1430 may be reduced, thereby increasing internal resistance. When the total area of the locking portions 1412 is less than 1%, an effect of preventing rotation of components may be reduced, which is undesirable. The surface area of the locking portion 1412 refers to the cross-sectional area of the engaging portion 1412 relative to the horizontal direction; that is, the direction parallel to the upper surface of the base plate 1410.

Meanwhile, a sum of the area (S, mm²) of the locking portions 1412 can be determined by the following Equation 1.

S=½×AB/C×N² (Equation 1)

(A is the length of the base plate (mm), B is the area of the opening relative to the area of the seating portion, C is the thickness of the base plate (mm), N is the number of locking portions).

If the base plate 1410 is relatively long or thin, the surface area of the engaging portion 1412 can be increased to enlarge the boundary area in vertical contact with the gasket 1420. In cases where the area of the opening 1415 is large relative to the width of the seating portion 1411, which makes it difficult to secure a sufficient contact area between the seating portion and the gasket 1420, the surface area of the engaging portion 1412 can be increased to prevent rotation of the gasket 1420.

Meanwhile, referring to FIG. 13, a length I of the locking portion 1412 may be 10 to 80%, preferably 20%, of a length of the short side of the seating portion 1411. When the length I of the locking portion 1412 exceeds 80% of the length of the short side of the seating portion 1411, a distance between the locking portion 1412 and a long side of the seating portion 1411 may be reduced, thereby making it difficult for the upper gasket 1420 to be smoothly seated. When the length I of the locking portion 1412 is less than 10% of the length of the short side of the seating portion 1411, an effect of preventing rotation of components may be reduced.

A width w of the locking portion 1412 may be 3 to 10%, preferably 5%, of a length of the long side of the seating portion 1411. When the width w of the locking portion 1412 exceeds 10% of the length of the long side of the seating portion 1411, an area of the lower surface of the terminal 1430 may be reduced, thereby increasing internal resistance.

The upper gasket 1420 is seated on the seating portion 1411 of the base plate 1410. As illustrated in FIG. 15, the upper gasket 1420 may include a bottom portion 1421, at least one fixing portion 1422, and a rib 1423. The bottom portion 1421 is a flat surface and has a contour identical to that of the seating portion 1411 of the base plate 1410. A lower surface of the bottom portion 1421 may be configured to have the same shape and size as the lower surface of the seating portion 1411 so as to correspond to the shape of the lower surface of the seating portion 1411. The difference in the lengths of the long sides of the seating portion 1411 and the bottom portion 1421 may be less than or equal to 0.05 mm.

At least one fixing portion 1422 is provided on at least one side of the bottom portion 1421. The fixing portion 1422 is coupled to the locking portion 1412 of the base plate 1410. In order to be coupled to the locking portion 1412 protruding from the seating portion 1411, the fixing portion 1422 has a concave space formed on an inner side thereof and has a convex shape toward an upper side. The same number of fixing portions 1422 may be formed as locking portions 1412, and the fixing portions 1422 may have the same shape as the locking portions 1412. A depth d1′ of the concave space inside the fixing portion 1422 may be equal to or greater than the depth d1 of the seating portion 1411.

An opening 1425 is formed at a center of the bottom portion 1421. During assembly of the cap assembly 1400 and the electrode assembly, the current collecting protrusion 1331 of the current collector 1300 is introduced through the opening 1425.

The rib 1423 is formed along a perimeter of the bottom portion 1421 of the upper gasket 1420. The rib 1423 is in close contact with a sidewall of the seating portion 1411 to seal the base plate 1410. The upper gasket 1420 has a container shape defined by the rib 1423 and the bottom portion 1421, and is configured to seat the terminal 1430. The rib 1423 projects upwardly from the bottom portion 1421 and has a height h1 greater than the depth d1 of the seating portion 1411. In addition, the height h1 of the rib 1423 may be 30 to 80%, preferably 50%, of a terminal height h2. When the height h1 of the rib 1423 is less than 30% of the terminal height h2, it may be difficult to stably seal the terminal 1430.

A thickness tL of the rib 1423 may be 0.5 to 1.2 mm. When the thickness tL of the rib 1423 is thinner than 0.5 mm, a sealing effect may be reduced.

The upper gasket 1420 may be made of an insulating material. The terminal 1430 and the base plate 1410 are insulated from each other by the upper gasket 1420.

Meanwhile, as illustrated in FIG. 14, two locking portions 1412 may be provided. The two rectangular locking portions 1412 may be disposed at symmetric positions with respect to the opening 1415 on one edge and the opposing edge of the seating portion 1411. When the locking portions 1412 are formed at symmetric positions, there is an advantage in that, during assembly of the components, it may not be necessary to separately align directions of components, thereby facilitating assembly. More specifically, the locking portions 1412 may be positioned symmetrically with respect to a virtual mirror line L bisecting the opening 1415, as shown in FIG. 13. In at least one alternative, the locking portions 1412 may be positioned asymmetrically with respect to the virtual mirror line L (that is, the locking portions 1412 may not have reflectional or mirror symmetry with respect to virtual mirror line L), but the locking portions 1412 may have rotational symmetry about the center of the opening 1415. An example of an arrangement having such rotational symmetry about the opening 1415 is illustrated in FIG. 15. Although the locking portions 1412 may alternatively be arranged completely asymmetrically, arranging them rotationally symmetrically has the above-noted advantage that, during assembly of the components, it may not be necessary to separately align directions of components, thereby facilitating assembly.

In another aspect, the seating portion 1411 may have a circular shape, and two rectangular locking portions 1412 may be respectively disposed on both sides of the seating portion 1411 (FIG. 16A). Four rectangular locking tabs 1412 may be arranged equidistantly around the periphery of the seating portion 1411 (FIG. 16B). In this instance, the width (w) of the locking tabs 1412 may be 3% to 15%, preferably 13%, of the length of the longer side of the seating portion 1411.

In another aspect, the seating portion 1411 is square, and four rectangular engaging portions 1412 may be respectively disposed at the center of each side of the seating portion 1411 (FIG. 17).

Meanwhile, a vent hole (not shown) and an electrolyte injection hole (not shown) may be formed in the base plate 1410. The vent hole is preferably designed to open to release gases when an internal pressure of the casing 1100 exceeds a reference value. In this aspect, the vent hole may be formed in the base plate 1410 or may be formed in the casing 1100. An electrolyte may be injected into the casing 1100 through the electrolyte injection hole. The terminal 1430 is coupled on the upper gasket 1420. At least one groove 1432 is formed on a lower surface of the terminal 1430. The groove 1432 is coupled to the fixing portion 1422 of the upper gasket 1420. An inner side of the groove 1432 is in contact with an upper surface of the fixing portion 1422. The engagement between the terminal 1430 and the upper gasket 1420 may be such as to reduce the possibility of rotation between the terminal 1430 and the upper gasket 1420. For example, the engagement between the rib 1423 and the terminal 1430 may restrict rotation between those components. Additionally, or alternatively, the engagement between the groove 1432 of the terminal 1430 and the fixing portion 1422 of the upper gasket 1420 may help to prevent relative rotation between those components.

The cap assembly 1400 is assembled by coupling the locking portion 1412 of the base plate 1410 with the lower surface of the fixing portion 1422 of the upper gasket 1420, and by coupling the upper surface of the fixing portion 1422 of the upper gasket 1420 with the groove 1432 of the terminal 1430.

When the base plate 1410, gasket 1420, and terminal 1430 are assembled sequentially, the openings of the base plate 1410, gasket 1420, and terminal 1430 can be aligned. The current collecting protrusion 1331 of the current collector 1300 can be inserted through the aligned openings. The current collecting protrusion 1331 may be caulked, and the outer circumferential surface of the end of the current collecting protrusion 1331 and the inner circumferential surface of the opening 1435 may be welded together.

Specifically, after a gasket 1420 and a terminal (1430) are sequentially stacked on a base plate 1410, a current-collecting protrusion 1331 may be passed through the space formed by the aligned openings of the base plate 1410, the gasket 1420, and the terminal 1430. The current-collecting protrusion 1331, having passed through to the upper surface of the terminal 1430, may be caulked and welded (FIG. 10A). Taking into account the width over which the current-collecting protrusion 1331 is caulked around the opening, the diameter of the opening may be set to 70% or less of the length of the shorter side of the terminal 1430.

The terminal 1430 is electrically connected to the electrode tabs 1220, 1230, 1240, and 1250 through the current collector 1300. The terminal 1430 may be configured like a plate having a circular shape or a quadrilateral shape. The terminal 1430 may be made of the same material as the casing 1100, which may be a metal such as aluminum or stainless steel.

When the base plate 1410, gasket 1420, and terminal 1430 are sequentially assembled, the openings of the base plate 1410, gasket 1420, and terminal 1430 can be aligned (FIG. 10A). The current collecting protrusion 1331 of the current collector 1300 can be inserted into the aligned openings. Accordingly, the cap assembly 1400 can be electrically connected to the electrode assembly 1200 via the current collector 1300.

In a modified aspect, an annular gasket 1440 may be inserted through the aligned openings (FIG. 10B). The upper portion of the annular gasket 1440 may contact the gasket 1420.

A rivet 1450 may be inserted into the opening of the annular gasket 1440 and caulked (FIG. 10B). Once the rivet 1450 secures the base plate 1410, the gasket 1420, and the terminal 1430, the current collecting protrusion 1331 of the current collector 1300 may be inserted into the rivet 1450. After the current collecting protrusion 1331 has been inserted into the opening 1435, the outer circumferential surface of the end of the current collecting protrusion 1331 and the inner circumferential surface of the opening 1435 of the terminal 1430 may be welded together.

The base plate 1410 may have a plate-like shape corresponding to the shape of the opening of the case 1100. The radius of curvature of the corners of the base plate 1410 may be 1 to 4 mm, for example 1.6 to 1.8 mm.

An opening 1435 may be formed in the terminal 1430. During assembly of the cap assembly 1400, the current collecting protrusion 1331 of the current collector 1300 is introduced through the opening 1435. After the current collecting protrusion 1331 is introduced into the opening 1435, the current collecting protrusion 1331 is caulked (e.g., sealed), and an outer peripheral surface of an end of the current collecting protrusion 1331 and an inner peripheral surface of the opening 1435 of the terminal 1430 may be welded to one another.

Specifically, after the upper gasket 1420 and the terminal 1430 are sequentially stacked on the base plate 1410, the current collecting protrusion 1331 may pass through a space in which the openings of the base plate 1410, the upper gasket 1420, and the terminal 1430 are aligned. The current collecting protrusion 1331 that passes through the upper surface of the terminal 1430 may be caulked and welded (FIG. 1). In consideration of a width by which the current collecting protrusion 1331 is caulked around the opening, a diameter of the opening may be set to 70% or less of a length of a short side of the terminal 1430.

The terminal 1430 may be electrically connected to the electrode tabs 1220, 1230, 1240, and 1250 through the current collector 1300.

In a modified aspect, after a gasket 1420 and a terminal 1430 are sequentially stacked on a base plate 1410, an annular gasket 1440 may be inserted into the space formed by the aligned openings of the base plate 1410, the gasket 1420, and the terminal 1430 (FIG. 10B). The upper portion of the annular gasket 1440 may be in contact with the gasket 1420.

A rivet 1450 may be inserted into the opening of an annular gasket 1440 and caulked at the upper portion of a terminal 1430 (FIG. 10B). A current-collecting protrusion 1331 of a current collector 1300 may be inserted into the opening formed by the rivet 1450 to connect with the terminal 1430. The outer circumferential surface of the end of the current-collecting protrusion 1331 may be welded to the inner circumferential surface of an opening 1435 in the terminal 1430.

A secondary battery including a cap assembly according to a second aspect of the present disclosure will be described. Configurations identical to those of the first aspect of the present disclosure will be omitted or briefly described.

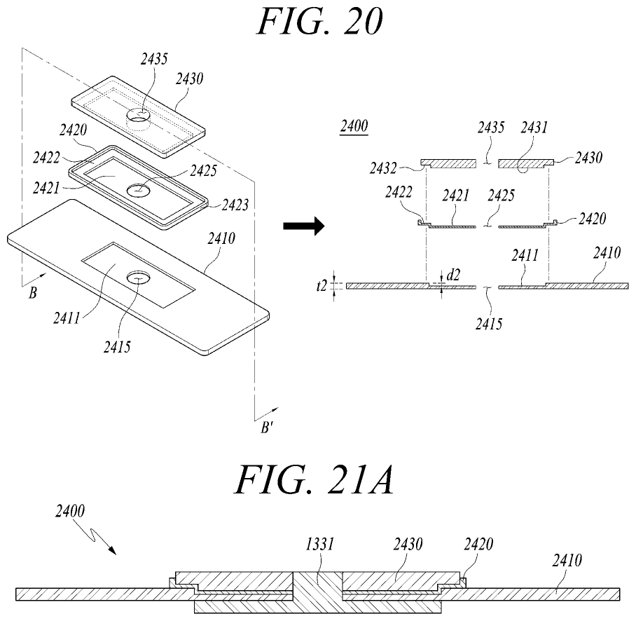

FIG. 20 includes views illustrating a cap assembly according to another aspect of the present disclosure.

As illustrated in FIG. 20, a cap assembly 2400 may include a base plate 2410, an upper gasket 2420, and a terminal 2430.

The base plate 2410 includes a seating portion 2411 and an opening 2415. The seating portion 2411 forms a flat surface recessed downward from an upper surface of the base plate 2410. The seating portion 2411 may have a rectangular shape or an elliptical shape. A lower surface of the seating portion 2411 is in contact with a lower surface of the upper gasket 2420. A height d2 of the seating portion 2411 may be 30 to 50% of a maximum thickness t2 of the base plate 2410. Meanwhile, the area of one seating portion 2411 relative to the base plate 2410 may be 8 to 20%, preferably 11% to 14%.

If the seating portion 2411 is rectangular, the curvature of the corners of the seating portion 2411 may be 2 to 3 mm, preferably 2.5 mm. To increase the coefficient of friction of the surface of the seating portion 2411, a material such as silicone may be applied to the surface of the seating portion 2411, or the surface roughness may be increased through surface treatment.

An opening 2415 is formed at a center of the seating portion 2411. During assembly of the cap assembly 2400, the current collecting protrusion 1331 of the current collector 1300 is introduced through the opening 2415. An area of the opening 2415 may be 5 to 20% of an area of the seating portion 2411, preferably 14%. By ensuring that the current collecting protrusion 1331 introduced through the opening 2415 has a sufficiently large diameter, internal resistance may be reduced when electricity generated in the secondary battery is output, thereby reducing heat generation.

The upper gasket 2420 is seated on the seating portion 2411 of the base plate 2410. The upper gasket 2420 may include a lower surface portion 2421, an upper surface portion 2422, and a rib 2423.

The lower surface portion 2421 is a flat surface and has a contour identical to that of the seating portion 2411 of the base plate 2410. A lower surface of the lower surface portion 2421 may be configured to have the same shape and size as a lower surface of the seating portion 2411 so as to conform to the shape of the lower surface of the seating portion 2411. As a result of such engagement, relative rotation between the upper gasket 2420 and the base plate 2410 may be reduced or prevented. The difference in the lengths of the long sides of the seating portion 2411 and the lower surface 2421 may be less than or equal to 0.05 mm.

An opening 2425 is formed at a center of the lower surface portion 2421. During assembly of the cap assembly 2400 and the electrode assembly, the current collecting protrusion 1331 of the current collector 1300 is introduced through the opening 2425. Additionally, an annular gasket, rivets, and current collection protrusions may be included.

The upper surface portion 2422 is connected to an outer periphery of the lower surface portion 2421. The upper surface portion 2422 is connected by a sidewall extending upward from the outer periphery of the lower surface portion 2421, thereby forming a step with the lower surface portion 2421. The upper surface portion 2422 has a predetermined width and is disposed outside the lower surface portion 2421 along a peripheral edge of the lower surface portion 2421. A lower surface of the upper surface portion 2422 is in contact with an upper surface of the base plate 2410.

The upper gasket 2420 may be made of an insulating material. The lower surface portion 2421 is in close contact with a lower surface of the seating portion 2411, and the upper surface portion 2422 is in close contact with an upper surface of the base plate 2410, thereby insulating the terminal 2430 from the base plate 2410.

An area of the upper surface portion 2422 may be 50 to 80% of an area of the lower surface portion 2421. By forming the upper surface portion 2422 to have an area of 50% or more of the area of the lower surface portion 2421, a beneficial size of the terminal 2430 may result. However, when the area of the upper surface portion 2422 exceeds 80% of the area of the lower surface portion 2421, the area of the lower surface portion 2421 may be relatively reduced, and thus an effect of preventing rotation of components may be reduced. A width of the upper surface portion 2422 may be 2 to 4 mm.

The rib 2423 is formed along a peripheral edge of the upper surface portion 2422. The upper gasket 2420 has a container shape defined by the rib 2423 and the upper surface portion 2422, and is configured to seat the terminal 2430. The rib 2423 projects upwardly from the upper surface portion 2422. The rib 2423 may be in close contact with a sidewall of the terminal 2430.

A thickness of the rib 2423 may be 0.5 to 1.2 mm. When the thickness of the rib 2423 is thinner than 0.5 mm, a sealing effect may be reduced.

The terminal 2430 is coupled on the upper gasket 2420. The terminal 2430 includes a protruding portion 2431 and a support portion 2432. The protruding portion 2431 constitutes a lower portion of the terminal 2430. The protruding portion 2431 is in contact with the lower surface portion 2421 of the upper gasket 2420. A protruding distance of the protruding portion 2431 may be equal to a depth of the lower surface portion 2421.

The support portion 2432 constitutes an upper portion of the terminal 2430. The support portion 2432 has a larger cross-sectional area than the protruding portion 2431, and an edge of the support portion 2432 is supported by the upper surface portion 2422 and the rib 2423 of the upper gasket 2420. The protruding portion 2431 is in contact with the lower surface portion 2421 of the upper gasket 2420, and the support portion 2432 is in contact with the upper surface portion 2422, thereby insulating and sealing the terminal 2430. A height of the rib 2423 may be 40 to 70% of a height of the support portion 2432 of the terminal. When the height of the rib 2423 is less than 40% of the height of the support portion 2432 of the terminal 2430, it is difficult to stably seal the terminal 2430. Moreover, as a result of engagement between the protruding portion 2431 of the terminal 2430 and the lower surface portion 2421 of the upper gasket 2420 and/or between the support portion 2432 of the terminal 2430 and the upper surface portion 2422 of the upper gasket 2420, the possibility of relative rotation between the terminal 2430 and the upper gasket 2420 may be reduced or prevented. Alternatively, or additionally, the engagement between the rib 2423 and the terminal 2430 may help to reduce or prevent relative rotation between the terminal 2430 and the upper gasket 2420.

The cap assembly 2400 is assembled by coupling the seating portion 2411 of the base plate 2410 with the lower surface of the lower surface portion 2421 of the upper gasket 2420, and by coupling the upper surface of the lower surface portion 2421 of the upper gasket 2420 with the protruding portion 2431 of the terminal 2430.

An opening 2435 may be formed through the protruding portion 2431 and the support portion 2432. The current collecting protrusion 1331 is introduced through the opening 2435. After the current collecting protrusion 1331 is introduced into the opening 2435, an outer peripheral surface of an end of the current collecting protrusion 1331 and an inner peripheral surface of the opening 2435 may be welded to one another.

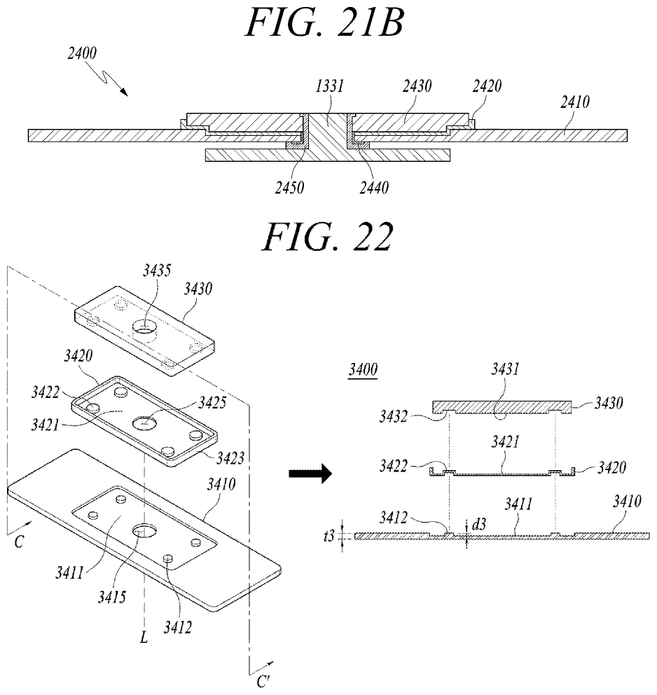

Specifically, after a gasket 2420 and a terminal 2430 are sequentially stacked on a base plate 2410, a current collecting protrusion 1331 may be passed through the space formed by the aligned openings of the base plate 2410, the gasket 2420, and the terminal 2430. The current collecting protrusion 1331, having passed through to the upper surface of the terminal 1430, may then be caulked and welded (FIG. 21A).

In a modified aspect, after a gasket 2420 and a terminal 2430 are sequentially stacked on a base plate 1410, an annular gasket may be inserted into the space formed by the aligned openings of the base plate 2410, the gasket 2420, and the terminal 2430. The upper portion of the annular gasket may be in contact with the gasket (FIG. 21B).

A rivet 2450 may be inserted into the opening of the annular gasket 2440 and stacked at the upper portion of the terminal 2430. The current-collecting protrusion 1331 may be inserted into the opening formed by the rivet and connected to the terminal. The outer peripheral surface of the end of the current-collecting protrusion 1331 may be welded to the inner peripheral surface of the opening 2435 of the terminal 2430 (FIG. 21B).

The terminal 2430 is electrically connected to the electrode tabs 1220, 1230, 1240, and 1250 through the current collector 1300.

A secondary battery including a cap assembly according to a third aspect of the present disclosure will be described. Configurations identical to those of the first aspect of the present disclosure will be omitted or briefly described.

FIGS. 22 to 25 are views illustrating cap assemblies according to other aspects of the present disclosure.

A cap assembly 3400 includes a base plate 3410, an upper gasket 3420, and a terminal 3430.

The base plate 3410 includes a seating portion 3411 and at least one protrusion 3412. The seating portion 3411 forms a flat surface recessed downward from an upper surface of the base plate 3410. The seating portion 3411 may have a quadrilateral shape or a circular shape. A lower surface of the seating portion 3411 is in contact with a lower surface of the upper gasket 3420. A height d3 of the seating portion 3411 may be 20 to 30% of a maximum thickness t3 of the base plate 3410. Meanwhile, the area of one seating portion 3411 relative to the base plate 3410 may be 8 to 20%, preferably 11% to 14%.

If the seating portion 3411 is rectangular, the radius of curvature of the corners of the seating portion 3411 may be 2 to 3 mm, and preferably 2.5 mm. To increase the coefficient of friction of the upper surface of the seating portion 3411, a material such as silicone may be applied to the surface of the seating portion 3411, or the surface roughness may be increased through surface treatment.

An opening 3415 is formed at a center of the seating portion 3411. During assembly of the cap assembly 3400, the current collecting protrusion 1331 of the current collector 1300 is introduced through the opening 3415. An area of the opening 3415 may be 5 to 20% of an area of the seating portion 3411, preferably 14%. By ensuring that the current collecting protrusion 1331 introduced through the opening 3415 has a sufficiently large diameter, internal resistance may be reduced when electricity generated in the secondary battery is output, thereby reducing heat generation.

One or more protrusions 3412 may be disposed on the seating portion 3411. The protrusions 3412 protrude from an upper surface of the seating portion 3411 by a predetermined height. The protrusions 3412 may have a circular shape, a polygonal shape, or a linear shape.

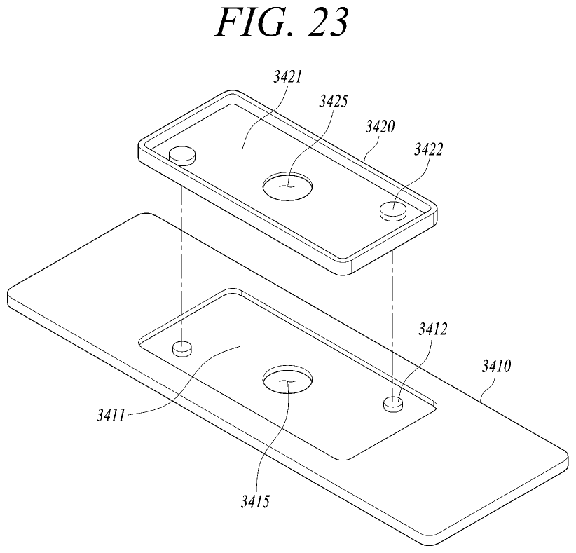

The engagement between either or both of the seating portion 3411 and the protrusions 3412 with the upper gasket 3420 may help to prevent rotation between the upper gasket 3420 and the base plate 3410. Accordingly, the protrusions 3412 may operate similarly to the locking portions 1412 discussed above in connection with the first aspect, and therefore the protrusions 3412 may also be referred to as “locking portions” herein. The shape of the seating portion 3411 and the shape and number of the protrusions 3412 may be selected as needed or as appropriate. For example, as illustrated in FIG. 22, the seating portion 3411 may have a rectangular shape. In addition, four cylindrical protrusions 3412 may be disposed near four corners of the seating portion 3411. When positions of the plurality of protrusions 3412 are set to be symmetric with respect to the opening 3415, there is an advantage in that, during assembly of the components, it may not be necessary to align directions of components, thereby facilitating assembly. More specifically, the protrusions 3412 (or locking portions) may be positioned symmetrically with respect to a virtual mirror line L bisecting the opening 3415, as shown in FIG. 22. In at least one alternative, the protrusions 3412 may be positioned asymmetrically with respect to the virtual mirror line L (that is, the protrusions 3412 may not have reflectional or mirror symmetry with respect to virtual mirror line L), but the protrusions 3412 may have rotational symmetry about the center of the opening 3415. An example of an arrangement having such rotational symmetry about the opening 3415 is illustrated in FIG. 23, discussed further below. Although the protrusions 3412 may alternatively be arranged completely asymmetrically, arranging them rotationally symmetrically has the above-noted advantage that, during assembly of the components, it may not be necessary to align directions of components, thereby facilitating assembly.

When a plurality of protrusions 3412 are formed on the seating portion 3411, a sum of areas of the plurality of protrusions may be 2 to 10% of an area of the seating portion 3411. The upper gasket 3420 and the terminal 3430 are sequentially stacked on the seating portion 3411 of the base plate 3410. When a total area of the protrusions 3412 exceeds 10%, an area of a lower surface of the terminal 3430 may be reduced, thereby increasing internal resistance. When the total area of the protrusions 3412 is less than 2%, an effect of preventing rotation of components may be reduced, which is undesirable. The area of the protrusion 3412 refers to the cross-sectional area of the protrusion 3412 based on the horizontal direction; that is, the direction parallel to the upper surface of the base plate 3410.

Meanwhile, a sum of the areas (S, mm²) of the protrusions 3412 can be determined by the following Equation (2).

S=⅛×AB/C×N² (Equation 2)

(A is the length of the base plate (mm), B is the area of the opening relative to the area of the seating portion, C is the thickness of the base plate (mm), N is the number of protrusions).

If the base plate 3410 is long or thin, the boundary area in contact with the gasket 3420 in the vertical direction can be increased by enlarging the surface area of the protrusions 3412 or by increasing their number. In cases where the surface area of the opening 3415 is large relative to that of the seating portion 3411, which makes it difficult to secure a sufficient contact area between the seating portion 3411 and the gasket 3420, the rotation of the gasket 3420 can be prevented by enlarging the surface area of the protrusions 3412 or by increasing their number.

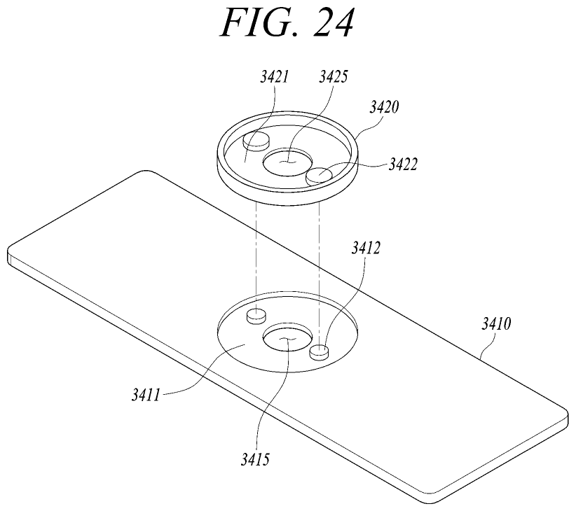

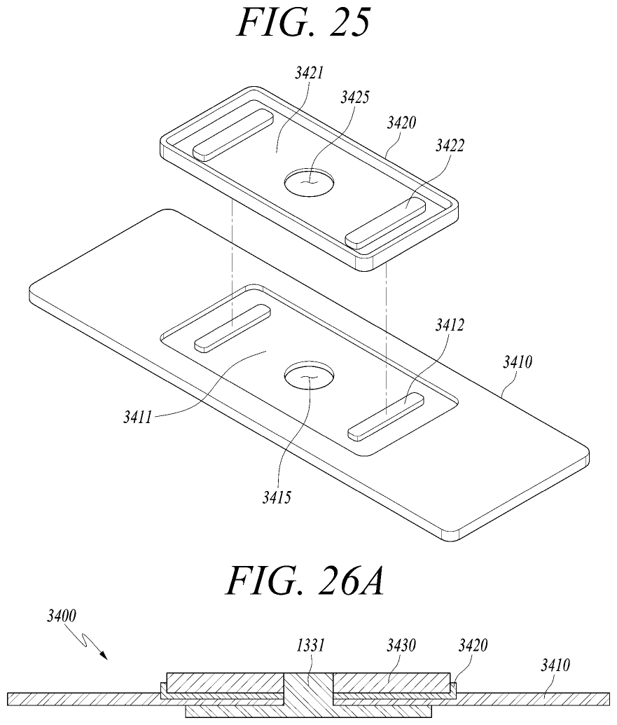

In another aspect, a seating portion 3411 may have a rectangular shape, and two protrusions 3412 may be disposed to be diagonally spaced apart from each other on the seating portion 3411 (FIG. 23), such that the two protrusions 3412 are rotationally symmetric with respect to one another about the center of the opening 3415. Alternatively, a seating portion 3411 may have a circular shape, and two protrusions 3412 may be disposed to be spaced apart from each other on the seating portion 3411 (FIG. 24). Alternatively, a seating portion 3411 may have a rectangular shape, and two linear protrusions 3412 may be disposed to be spaced apart from each other on the seating portion 3411 (FIG. 25). The protrusions may be one of a cylindrical shape, an elliptic cylindrical shape, and a quadrangular prismatic shape.

The upper gasket 3420 is seated on the seating portion 3411 of the base plate 3410. The upper gasket 3420 may include a bottom portion 3421, at least one fixing portion 3422, and a rib 3423. The bottom portion 3421 is a flat surface and has a contour identical to that of the seating portion 3411 of the base plate 3410. A lower surface of the bottom portion 3421 may be configured to have the same shape and size as a lower surface of the seating portion 3411 so as to correspond to the shape of the lower surface of the seating portion 3411.

An opening 3425 is formed at a center of the bottom portion 3421. During assembly of the cap assembly 3400 and the electrode assembly, the current collecting protrusion 1331 of the current collector 1300 is introduced through the opening 3425.

At least one fixing portion 3422 is provided on the bottom portion 3421. The fixing portion 3422 is coupled to the protrusion 3412 of the base plate 3410. In order to be coupled to the protrusion 3412 protruding from the seating portion 3411, the fixing portion 3422 has a concave space formed on an inner side thereof and has a convex shape toward an upper side. The fixing portion 3422 may have the same shape as the protrusion 3412.

The rib 3423 is formed along an edge of an upper surface of the bottom portion 3421. The rib 3423 is in close contact with a sidewall of the seating portion 3411 to seal the base plate 3410. The upper gasket 3420 has a container shape defined by the rib 3423 and the bottom portion 3421, and is configured to seat the terminal 3430. The rib 3423 projects upwardly from the bottom portion 3421 and has a height greater than a depth of the seating portion 3411.

In addition, a height of the rib 3423 may be 10 to 70%, preferably 20% of a terminal height. When the height of the rib 3423 is less than 10% of the terminal height, it is difficult to stably seal the terminal 3430. A thickness of the rib 3423 may be 0.5 to 1.2 mm. When the thickness of the rib 3423 is thinner than 0.5 mm, a sealing effect may be reduced.

The upper gasket 3420 may be made of an insulating material. The terminal 3430 and the base plate 3410 are insulated from each other by the upper gasket 3420.

The terminal 3430 is coupled on the upper gasket 3420. At least one groove 3432 is formed on a lower surface 3431 of the terminal 3430. The groove 3432 is coupled to the fixing portion 3422 of the upper gasket 3420. An inner side of the groove 3432 is in contact with an upper surface of the fixing portion 3422. The engagement between the terminal 3430 and the upper gasket 3420 may be such as to reduce the possibility of rotation between the terminal 3430 and the upper gasket 3420. For example, the engagement between the rib 3423 and the terminal 3430 may restrict rotation between those components. Additionally, or alternatively, the engagement between the groove 3432 of the terminal 3430 and the fixing portion 3422 of the upper gasket 3420 may help to prevent relative rotation between those components.

The cap assembly 3400 is assembled by coupling the protrusion 3412 of the base plate 3410 with a lower surface of the fixing portion 3422 of the upper gasket 3420, and by coupling an upper surface of the fixing portion 3422 of the upper gasket 3420 with the groove 3432 of the terminal 3430. The protrusions 3412, the fixing portions 3422, and the grooves 3432 may be provided in the same number and may be disposed at corresponding positions.

An opening 3435 may be formed in the terminal 3430. During assembly of the cap assembly 3400, the current collecting protrusion 1331 of the current collector 1300 is introduced through the opening 3435. After the current collecting protrusion 1331 is introduced into the opening 3435, an outer peripheral surface of an end of the current collecting protrusion 1331 and an inner peripheral surface of the opening 3435 may be welded.

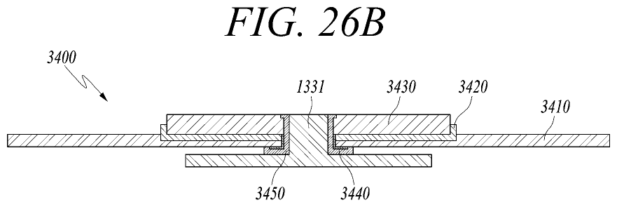

Specifically, after a gasket 3420 and a terminal 3430 are sequentially stacked on a base plate 3410, a current collecting protrusion 1331 may be passed through the space formed by the aligned openings of the base plate 3410, the gasket 3420, and the terminal 3430. The current collecting protrusion 1331, having passed through to the upper surface of the terminal 1430, may be caulked and welded (FIG. 26A).

In a modified aspect, after a gasket 3420 and a terminal 3430 are sequentially stacked on a base plate 3410, an annular gasket 3440 may be inserted into the space formed by the aligned openings of the base plate 3410, the gasket 3420, and the terminal 3430. The upper portion of the annular gasket 3440 may be in contact with the gasket 3420.

A rivet 3450 may be inserted into the opening of the annular gasket 3440 and caulked at the upper portion of the terminal 3430. The current-collecting protrusion 1331 may be inserted into the opening formed by the rivet to connect with the terminal. The outer circumferential surface of the end of the current-collecting protrusion 1331 may be welded to the inner circumferential surface of the opening 3435 of the terminal 3430 (FIG. 26B).

The terminal 3430 is electrically connected to the electrode tabs 1220, 1230, 1240, and 1250 through the current collector 1300.

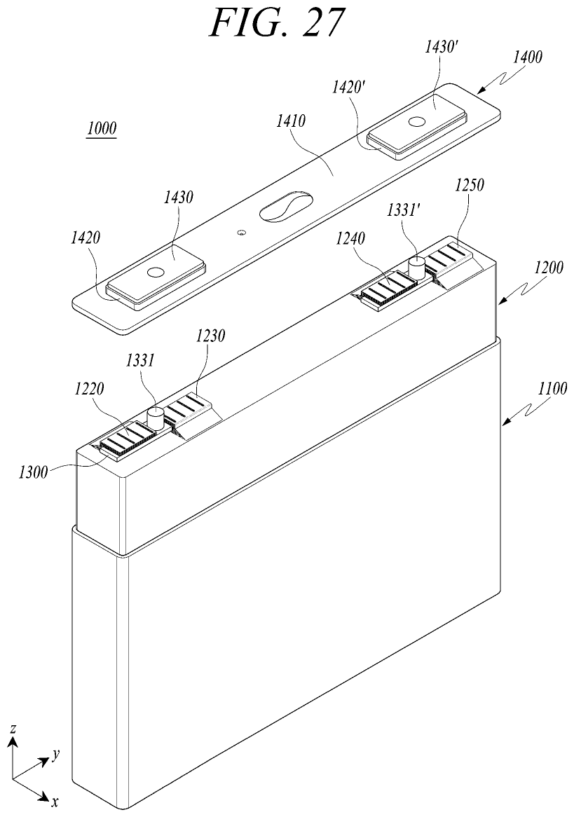

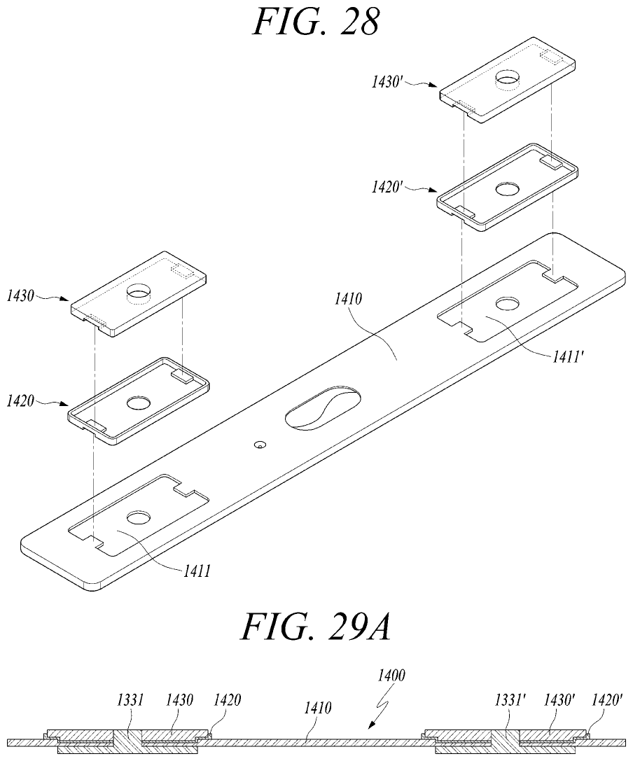

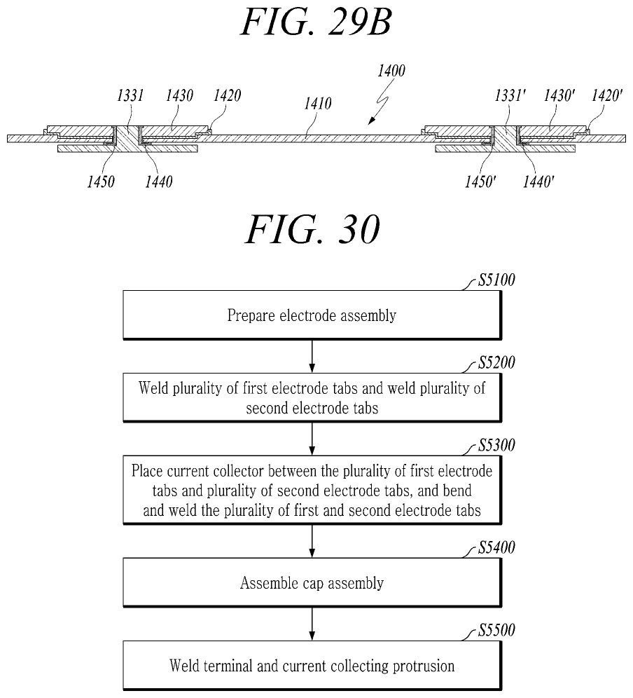

FIG. 27 is an exploded view illustrating a secondary battery according to an aspect of the present disclosure. FIG. 28 is an exploded view illustrating a cap assembly of a secondary battery according to an aspect of the present invention. FIGS. 29A and 29B are cross-sectional views illustrating the state in which a cap assembly and a current collector are coupled in a secondary battery according to additional aspects of the present disclosure.

As illustrated in FIGS. 27 and 28, in a secondary battery according to an aspect of the present invention, a cap assembly 1400 equipped with two electrode terminals may be disposed at one end of a case 1100. An opening may be formed at one end of the case 1100, and a single cap assembly 1400 may be coupled to the case 1100 to seal the opening.

A cap assembly 1400 may be formed by coupling gaskets 1420, 1420′ and terminals 1430, 1430′ to respective seating portions 1411, 1411′ formed on a base plate 1410. When the gasket 1420 and terminal 1430 are sequentially coupled to the seating portion 1411 of the base plate 1410, and the gasket 1420′ and terminal 1430′ are sequentially coupled to the seating portion 1411′, the openings of the base plate 1410, gasket 1420, and terminal 1430 become aligned, and the openings of the base plate 1410, gasket 1420′, and terminal 1430′ also become aligned. A current-collecting protrusion 1331 may pass through the space formed by the aligned openings of the base plate 1410, gasket 1420, and terminal 1430.

The current-collecting protrusion 1331, having passed through the opening, may be caulked and welded to the upper surface of the terminal 1430 (FIG. 29A). Taking into account the width over which the current-collecting protrusion 1331 is caulked around the opening, the diameter of the opening may be set to 70% or less of the length of the shorter side of the terminal 1430.

In a modified aspect, after a gasket 1420 and a terminal 1430 are sequentially stacked on a base plate 1410, an annular gasket 1440 may be inserted into the space formed by the aligned openings of the base plate 1410, the gasket 1420, and the terminal 1430. The upper portion of the annular gasket 1440 may be in contact with the gasket 1420.

A rivet 1450 may be inserted into the opening of the annular gasket 1440 and caulked at the upper portion of the terminal 1430. The current-collecting protrusion 1331 may be inserted into the opening formed by the rivet 1450 to connect with the terminal. The outer circumferential surface of the end of the current-collecting protrusion 1331 may be welded to the inner circumferential surface of the opening 1435 of the terminal 1430 (FIG. 29B).

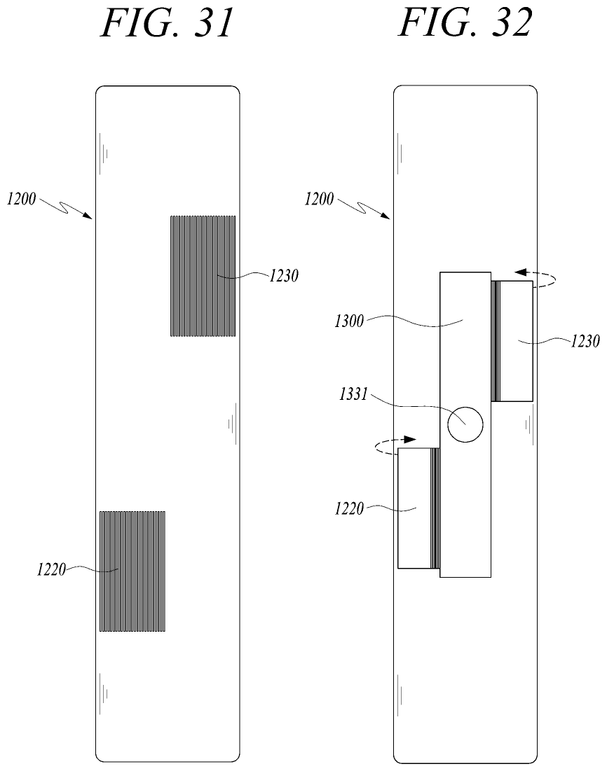

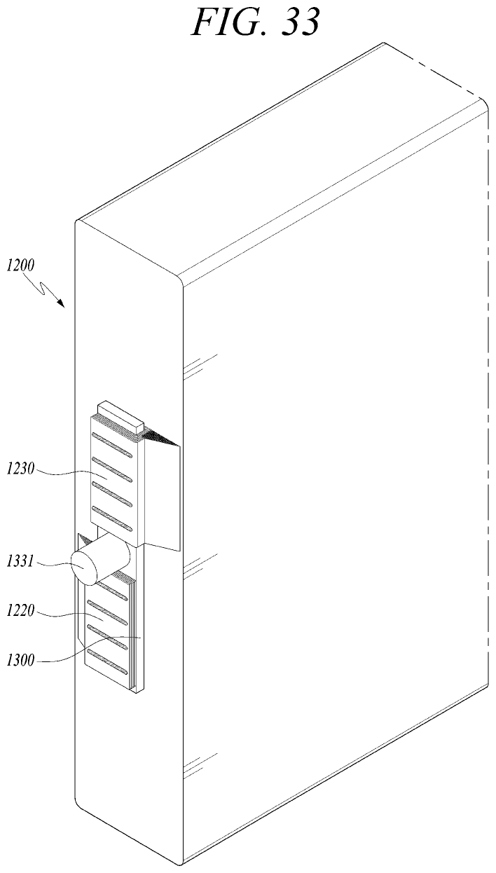

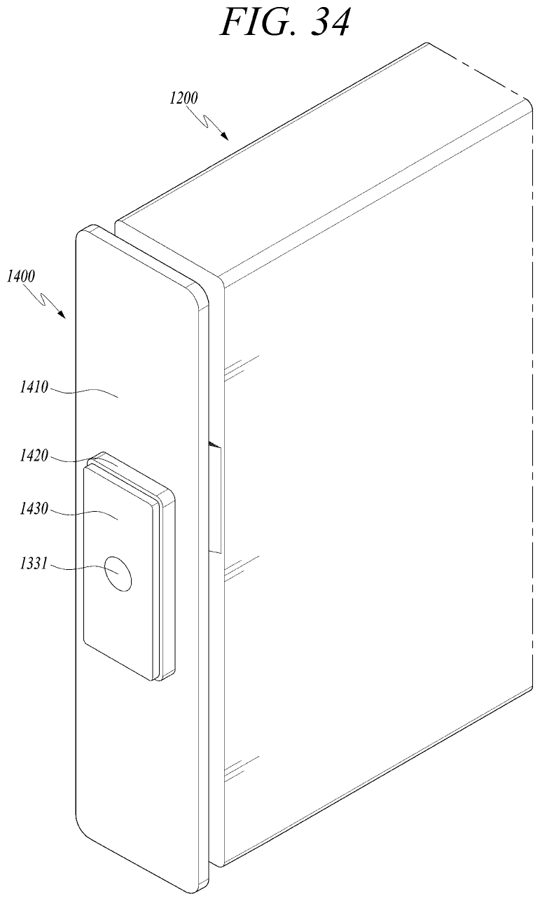

FIG. 30 is a flowchart illustrating a method of manufacturing a secondary battery according to one aspect of the present disclosure. FIG. 31 is a view illustrating a state in which a plurality of first electrode tabs and a plurality of second electrode tabs are respectively grouped in a secondary battery according to one aspect of the present disclosure. FIG. 32 is a view illustrating a state in which a current collector is disposed between a plurality of first electrode tabs and a plurality of second electrode tabs in a secondary battery according to one aspect of the present disclosure. FIG. 33 is a view illustrating a state in which a current collector and first and second electrode tabs are welded in a secondary battery according to one aspect of the present disclosure. FIG. 34 is a view illustrating a state in which a cap assembly is coupled to an electrode assembly in a secondary battery according to one aspect of the present disclosure.

As illustrated in FIG. 30, in order to manufacture a secondary battery according to one aspect of the present disclosure, an electrode assembly is prepared (S5100). The electrode assembly 1200 includes an electrode portion 1210, a plurality of first electrode tabs 1220 and a plurality of second electrode tabs 1230 which are formed at one end of the electrode portion.

The plurality of first electrode tabs 1220 and the plurality of second electrode tabs 1230 are disposed at one end of the electrode portion 1210. When a plurality of electrode members forming the electrode portion are stacked, the plurality of first electrode tabs 1220 overlap each other at a first position, and the plurality of second electrode tabs 1230 overlap each other at a second position. That is, the plurality of first electrode tabs 1220 are grouped at the first position, and the plurality of second electrode tabs 1230 are grouped at the second position. The first position and the second position are spaced apart from each other on the electrode members, and the grouped plurality of first electrode tabs 1220 and the grouped plurality of second electrode tabs 1230 may be spaced apart from each other in a width direction and a length direction of the electrode assembly 1200. As illustrated in FIG. 31, the grouped plurality of first electrode tabs 1220 may be disposed at one end in the width direction of the electrode assembly, and the grouped plurality of second electrode tabs 1230 may be disposed at the other end in the width direction of the electrode assembly 1200.

Next, the plurality of first electrode tabs 1220 are welded to each other, and the plurality of second electrode tabs 1230 are welded to each other (S5200). The plurality of first electrode tabs 1220 and the plurality of second electrode tabs 1230 are aligned to be spaced apart from each other in a length direction of the electrode assembly 1200. The grouped and aligned plurality of electrode tabs are primarily welded such that the first electrode tabs 1220 are welded to each other and the second electrode tabs 1230 are welded to each other.

After the current collector 1300 is disposed between the primarily welded plurality of first electrode tabs 1220 and plurality of second electrode tabs 1230 (FIG. 32), the plurality of first and second electrode tabs 1220 and 1230 are welded thereto (S5300) (FIG. 33). In order to connect the plurality of electrode tabs 1220 and 1230 to the current collector 1300, in this aspect, electrode tabs 1220 and 1230 having the same polarity are divided into two groups and welded to the current collector 1300.

At one end of the electrode portion 1210, a space is formed between the primarily welded plurality of first electrode tabs 1220 and plurality of second electrode tabs 1230. In order to facilitate disposition of the current collector 1300, the welded plurality of first electrode tabs 1220 and the welded plurality of second electrode tabs 1230 may be bent toward the outer side of the electrode assembly 1200 in the width direction, respectively. The current collector 1300 is placed between the first electrode tabs 1220 and the second electrode tabs 1230, and the first electrode tabs 1220 and the second electrode tabs 1230 are bent toward an upper surface of the current collector 1300, respectively (FIG. 32). The plurality of first electrode tabs 1220 are bent onto an upper surface of the first current collecting portion 1310 of the current collector 1300, and the plurality of second electrode tabs 1230 are bent onto an upper surface of the second current collecting portion 1320 of the current collector 1300. The plurality of first electrode tabs 1220 and the plurality of second electrode tabs 1230 are bent in opposite directions.

The current collector 1300 and the first and second electrode tabs 1220 and 1230 placed on the current collector 1300 are welded (FIG. 33). The plurality of first electrode tabs 1220 are welded to the first current collecting portion 1310, and the plurality of second electrode tabs 1230 are welded to the second current collecting portion 1320. Welding may be performed on upper portions of the plurality of first electrode tabs 1220 and the plurality of second electrode tabs 1230. The welding may be performed using a method such as ultrasonic welding or laser welding.

During welding, welding may proceed toward the first current collecting portion 1310 from the plurality of first electrode tabs 1220 at the first current collecting portion 1310 of the current collector 1300, and welding may proceed toward the second current collecting portion 1320 from the plurality of second electrode tabs 1230 at the second current collecting portion 1320 of the current collector 1300.

In this aspect, the plurality of electrode tabs are primarily welded such that the first electrode tabs 1220 are welded to each other and the second electrode tabs 1230 are welded to each other, and are then welded to the current collector 1300. However, in another aspect, the plurality of electrode tabs 1220 and 1230 may be directly bent onto the current collector 1300 and welded thereto without performing the primary welding.

The electrode assembly 1200 to which the current collector 1300 is welded is accommodated in the casing 1100, and the cap assembly 1400 seals the opening of the casing 1100 to be assembled (S5400).

After the current collecting protrusion 1321 is inserted into a through hole of the terminal 1420 of the cap assembly 1400, the outer peripheral surface of the end of the current collecting protrusion 1321 and the inner peripheral surface of an end of the through hole are welded together (S5500).

Conventionally, when the current collector is welded on the upper portion of the electrode tabs, the thickness of the current collector needs to be reduced to transfer heat to electrode tabs located on a lower side, which leads to deterioration of durability. However, according to the present disclosure, the plurality of electrode tabs are bent and welded onto the current collector such that a desired thickness of the current collector may be maintained and the electrode tabs may be more efficiently welded to the current collector.

In addition, according to the present disclosure, a plurality of electrode tabs having the same polarity are divided into two groups and welded, so that the electrode tabs may be stably welded without regions that fail to be completely welded. That is, by dividing the electrode tabs of the same polarity into multiple groups, the stacked thickness of any one group of electrode tabs to be welded may be reduced, such that the stack of electrode tabs may be more easily welded through the thickness of the resulting stack.

According to the present disclosure, since the electrode tabs are positioned on the current collector 1300 and welding is performed on the upper portion of the electrode tabs, the thickness of the current collector may be increased, which reduces the concern of damaging the separator provided in the electrode portion. Thus, the durability of the secondary battery may also be improved.

A battery module may be configured by including a plurality of secondary batteries according to any of the above aspects. The plurality of secondary batteries may be connected to each other by a busbar or the like to form the battery module. In addition, a battery pack may be configured by including a plurality of battery modules. The battery pack may be configured by disposing the plurality of battery modules in an upper pack housing and a lower pack housing that constitute a pack housing. Further, the battery pack may be utilized in a transportation means that moves luggage or people or performs work while moving. Such a transportation means may include a bicycle, heavy equipment, agricultural and fishery equipment, an automobile, a bus, and an aircraft. Any such automobile may be an electric vehicle, a hybrid vehicle, or a plug-in hybrid vehicle. The automobile may include a four-wheeled vehicle or a two-wheeled vehicle. The transportation means may be operated by power supplied from the battery pack.

According to one aspect of the present disclosure, a secondary battery, and a module, a pack, and a transportation means including the same, can avoid having an electrode assembly that is affected when welding an electrode tab to a current collector.

Further, according to one aspect of the present disclosure, a secondary battery, and a module, a pack, and a transportation means including the same, can have a large number of electrode tabs welded to a current collector.

Furthermore, according to one aspect of the present disclosure, a secondary battery, and a module, a pack, and a transportation means including the same, can prevent rotation of components while simplifying an assembly process of a cap assembly. For instance, the ability of components of the cap assembly to rotate with respect to one another may be further reduced in any of the above aspects by having the terminal disposed on an upper surface of the upper gasket, such that a lower surface of the terminal is positioned below an upper surface of the base plate. For example, by designing the thickness of the bottom portions 1421, 3421 of the respective upper gaskets 1420, 3420 relative to the depth d1, d3 of the seating portion 1411, 3411 in which the respective upper gasket 1420, 3420 sits, the lower surface 1431, 3431 of the respective terminal 1430, 3430 may be positioned lower (i.e., closer to the electrode assembly 1200 within the casing 1100) than the upper surface of the base plate 1410, 3410. As a result, the upper gasket 1420, 3420 may be less likely to cant under lateral or rotational force applied to the terminal 1430, 3430 because the higher upper surface of the base plate 1410, 3410 would act as a physical stop that blocks further movement of the terminal 1430, 3430 even under extreme deformation of the upper gasket 1420, 3420.

While the present disclosure has been described with respect to the specific aspects, it will be apparent to those skilled in the art that various changes or modifications of the present disclosure are possible by adding, changing, or deleting components without departing from the spirit of the present disclosure as defined in the following claims.

What is claimed is:

1. A secondary battery, comprising:
an electrode assembly including an electrode portion and at least one electrode tab positioned at a first end of the electrode portion;
a current collector disposed along the first end of the electrode portion and welded to the at least one electrode tab;
a battery casing having an open end and accommodating the electrode assembly therein such that the open end of the battery casing is proximate the first end of the electrode portion; and
a cap assembly coupled to the open end of the battery casing,
wherein the cap assembly includes:
a base plate including a seating portion defining a recess into the base plate and including an opening through which extends a current collecting protrusion in electrical communication with the at least one electrode tab of the electrode assembly, the base plate including a plurality of locking portions positioned along the seating portion asymmetrically with respect to a virtual mirror line bisecting the opening of the seating portion;
a gasket disposed in the seating portion of the base plate, the gasket including a bottom portion and a plurality of fixing portions disposed along the bottom portion, the plurality of fixing portions being coupled to the respective plurality of locking portions; and
a terminal disposed on an upper surface of the bottom portion of the gasket, the terminal having a plurality of grooves positioned along a lower surface thereof and receiving the respective fixing portions of the gasket therein.

2. The secondary battery according to claim 1, wherein the seating portion has a quadrilateral shape or a circular shape.

3. The secondary battery according to claim 1, wherein a depth of the seating portion is in a range of 30% to 50% of a thickness of the base plate.

4. The secondary battery according to claim 1, wherein an area of the opening of the base plate is in a range of 5% to 20% of an area of the seating portion.

5. The secondary battery according to claim 1, wherein the plurality of locking portions are positioned rotationally symmetrically with respect to a center of the opening of the seating portion.

6. The secondary battery according to claim 1, wherein a sum of areas of the plurality of locking portions is in a range of 8% to 20% of an area of the seating portion.

7. The secondary battery according to claim 1, wherein the seating portion has a quadrilateral shape having a long dimension and a short dimension, and wherein the plurality of locking portions protrude into the seating portion from an outer perimeter thereof.

8. The secondary battery according to claim 7, wherein a length that each of the plurality of locking portions protrude into the seating portion along the short dimension of the seating portion is in a range of 10% to 80% of a length of the short dimension of the seating portion.

9. The secondary battery according to claim 7, wherein a width of each of the plurality of locking portions along the long dimension of the seating portion is in a range of 3% to 10% of a length of the long dimension of the seating portion.

10. The secondary battery according to claim 1, wherein the plurality of locking portions include at least one protrusion extending upwardly from the recess defined by the seating portion, the at least one protrusion being spaced away from a perimeter of the seating portion.

11. The secondary battery according to claim 1, wherein the fixing portion has a convex shape disposed on the upper surface of the bottom portion of the gasket and a concave shape disposed on a lower surface of the bottom portion of the gasket.

12. The secondary battery according to claim 1, wherein the gasket includes a rib positioned along a peripheral edge of the upper surface of the bottom portion.

13. The secondary battery according to claim 12, wherein a height of the rib above the upper surface of the bottom portion of the gasket is in a range 30% to 80% of a height of the terminal.

14. The secondary battery according to claim 12, wherein the rib has a longitudinal dimension extending along the perimeter edge of the bottom portion of the gasket, the rib projecting away from the upper surface of the bottom portion in a height dimension, and the rib having a thickness dimension orthogonal to the height dimension and the thickness dimension, a thickness of the rib in the thickness dimension being in a range of 0.5mm to 1.2mm.

15. The secondary battery according to claim 1, wherein a sum of an area(S) of the plurality of locking portions is determined by the following:
S=½×AB/C×N² (Equation 1)
wherein A is a length of the base plate (mm), B is an area of the opening relative to the area of the seating portion, C is a thickness of the bas e plate (mm), N is a quantity of the plurality of locking portions.

16. The secondary battery according to claim 1, wherein a sum of an area(S) of the plurality of locking portions is determined by the following:
S=⅛×AB/C×N² (Equation 1)
wherein A is a length of the base plate (mm), B is an area of the opening relative to an area of the seating portion, C is a thickness of the base plate (mm), N is a quantity of the plurality of locking portions.

17. A secondary battery, comprising:
an electrode assembly including an electrode portion and at least one electrode tab positioned at a first end of the electrode portion;
a current collector disposed along the first end of the electrode portion and welded to the at least one electrode tab;
a battery casing having an open end and accommodating the electrode assembly therein such that the open end of the battery casing is proximate the first end of the electrode portion; and
a cap assembly coupled to the open end of the battery casing,
wherein the cap assembly includes:
a base plate including a seating portion defining a recess into the base plate;
a gasket disposed in the seating portion of the base plate, the gasket including an upwardly-facing surface facing away from the base plate, the upwardly-facing surface including a lower surface portion, an upper surface portion, and a rib, the upper surface portion projecting upwardly from the lower surface portion along an outer peripheral region of the lower surface portion, thereby defining a step between the lower surface portion and the upper surface portion, and the rib extending along a peripheral edge of the upper surface portion; and
a terminal disposed on the upwardly-facing surface of the gasket, the terminal having a groove extending along a peripheral portion of a lower surface thereof, the groove receiving the step defined by the upper surface portion of the gasket.

18. The secondary battery according to claim 17, wherein a depth of the seating portion is in a range of 30% to 50% of a thickness of the base plate.

19. The secondary battery according to claim 17, wherein an area of the upper surface portion is in a range of 50% to 80% of an area of the lower surface portion.

20. The secondary battery according to claim 17, wherein a width of the upper surface portion is in a range of 2 mm to 4 mm.

21. The secondary battery according to claim 13, wherein the lower surface portion has a shape being the same as a shape of the seating portion.

22. A secondary battery, comprising:
an electrode assembly including an electrode portion and at least one electrode tab positioned at a first end of the electrode portion;
a current collector disposed along the first end of the electrode portion and welded to the at least one electrode tab;
a battery casing having an open end and accommodating the electrode assembly therein such that the open end of the battery casing is proximate the first end of the electrode portion; and
a cap assembly coupled to the open end of the battery casing,
wherein the cap assembly includes:
a base plate including a seating portion defining a recess into the base plate;
a gasket disposed in the seating portion of the base plate, the gasket including a bottom portion and a rib positioned along a peripheral edge of an upper surface of the bottom portion; and
a terminal disposed on the upper surface of the gasket, such that a lower surface of the terminal is below an upper surface of the base plate.
